(19) United States
(12) Patent Application Publication
(10) Pub. No.: US 2014/0257991 A1
(43) Pub. Date: Sep. 11, 2014

(54) SYSTEM AND METHOD FOR REAL-TIME PRIORITIZED MARKETING

(71) Applicants: Michael Christensen, Toronto (CA); Hilton Hiu Tung Lee, Markham (CA); Sing Yoong Khew, Kirkland, WA (US)

(72) Inventors: Michael Christensen, Toronto (CA); Hilton Hiu Tung Lee, Markham (CA); Sing Yoong Khew, Kirkland, WA (US)

(73) Assignee: DEALBARK INC., Toronto, Ontario (CA)

(21) Appl. No.: 14/238,334

(22) PCT Filed: Aug. 13, 2012
(86) PCT No.: PCT/CA2012/050548

§ 371 Date: May 27, 2014

Related U.S. Application Data
(60) Provisional application No. 61/522,826, filed on Aug. 12, 2011.

(51) Int. Cl. G06Q 30/02

(52) U.S. Cl. CPC G06Q 30/0269
USPC 705/14.66

(57) ABSTRACT

Computer-implemented methods are provided for the delivery and/or prioritization of electronic marketing and promotional offers to a client device. In some embodiments, user context information associated with a user, and/or extrinsic context information, is employed to identify matching offers for a user, and to prioritize and optionally rank a subset of the matching offers. In other embodiments, user context information, and optionally extrinsic context information, is employed to dynamically trigger the activation and optional customization of offers for users, according to triggering logic and trigger parameters. In other embodiments, extrinsic context information is employed for triggering the availability of offers to one or more users, according to triggering logic and trigger parameters.

### CROSS-REFERENCE TO RELATED APPLICATION

This application claims priority to U.S. Provisional Application No. 61/522,826 titled “SYSTEM AND METHOD FOR REAL-TIME PRIORITIZED MARKETING” and filed on Aug. 8^{th}, 2011, the entire contents of which are incorporated herein by reference.

### BACKGROUND

The marketing and advertising industry has traditionally operated by defining and implementing marketing plans using traditional media and internet advertisements, or “ads”. Specifically, marketing via traditional media has meant marketing via defined channels such as print (newspapers, magazines, flyers, billboards, branded pens, etc.), video (TV, and product placement in TV shows or movies), and sponsorship of events or objects such that the brand and the associated messages are reinforced. Traditionally, marketing has not targeted the actual needs of individual users, but rather has been based on getting as many impressions (views by an audience) as possible. Furthermore, traditional marketing methods tend to involve long cycles of delivery.

With the advent of the internet merchants have developed websites to advertise their goods and services to users of the internet. In addition to having a website, there has been a move by some merchants to advertise using web-based banner ads which display on websites and search-engine result pages.

These internet advertisements have generally been targeted to a user based on the page content of a page the user happens to be browsing, the website or web application being used, or the browsing history of a user, in an attempt to display a message relevant to the user or the user context. This has been of limited success in terms of click-through rates (the number of users who express interest by actually clicking on the ad), with an average click-through rate that is only expected to be about 0.2-0.3%. This tends to occur because the use of the page content, website or web application, or browse history to drive ad selection and display does not necessarily reflect goods or services the user is actually interested in. As an example, just because a user conducts searches on the Google™ website for “tiger” for a science project, or a user gets an email from a cousin about surfing in Hawaii, it does not necessarily mean that as a consumer, the user is interested in goods or services related to those topics.

In addition to the limited ability to target users, traditional marketing mechanisms and campaigns tends to involve a long-cycle to delivery. That is, the merchant with goods or services to market, must plan the campaign far in advance—normally days, weeks, or often months in advance of seeing the marketing message delivered via the selected channel or channels, although it is possible to sometimes plan this at least several hours in advance. It has not been possible for a merchant to create a promotional ad independently, and deliver it within seconds to target users who want that message, as the technology and systems have not existed. As such, specific good or service promotions have had to be well-planned in advance.

Due to the time-to-market issue, campaigns today tend to last several days or weeks. Merchants have difficulty capitalizing on immediate situations presented to them day-to-day, or hour-to-hour. A new system and method that can allow a merchant to launch, modify and remove campaigns in real-time can therefore be advantageous.

Traditional marketing mechanisms tend to be based on the “flood” model—display the message to as many people as possible, in the hopes that a small percentage will be interested in (respond to) the message. Campaigns are often priced by cost-per-thousand impressions (CPM) or cost-per-point (CPP) for cost for an individual impression. There have been attempts target delivery of the message to a receptive audience, by demographics analysis of neighbourhoods, print buyers, TV show audiences, and so forth.

However, such marketing strategies are implemented essentially by the merchant/marketer, as the advertising message is usually not requested by the consumer. On the contrary, many marketing messages end up as nothing but a nuisance to the consumer, something that they live with, but try to avoid if possible. The marketer traditionally has had no choice but to send the message as broadly as possible, keeping budget in mind, in hopes of getting the most visibility, and thus increasing the number of people making up the low response-rate.

### SUMMARY

Computer-implemented methods are provided for the delivery and/or prioritization of electronic marketing and promotional offers to a client device. In some embodiments, user context information associated with a user, and/or extrinsic context information, is employed to identify matching offers for a user, and to prioritize and optionally rank a subset of the matching offers. In other embodiments, user context information, and optionally extrinsic context information, is employed to dynamically trigger the activation and optional customization of offers for users, according to triggering logic and trigger parameters. In other embodiments, extrinsic context information is employed for triggering the availability of offers to one or more users, according to triggering logic and trigger parameters.

According, in one aspect, there is provided a method of determining a prioritized subset of electronic offers for display on a client device associated with a user, the method comprising:
a) obtaining user context information associated with the user;
b) obtaining, a set of valid offers that are associated with the user context information;
c) processing the set of valid offers and the user context information to identify a set of matching offers that is relevant to the user; and
d) processing the set of matching offers and the user context information according to offer prioritization rules to obtain a prioritized subset of the matching offers for display on the client device.

In another aspect, there is provided a method of dynamically triggering the availability of an offer for display on a client device, the method comprising:
a) obtaining a set of offers, at least one of said set of offers having associated therewith one or more customized offer trigger parameters and triggering logic, wherein the customized offer trigger parameters are dependent on user context information associated with a user of the client device;
b) obtaining the user context information and evaluating the customized offer trigger parameters for each offer; and
c) processing the triggering logic and the customized offer trigger parameters, and dynamically triggering a matching offer when the triggering logic is satisfied.

In another aspect, there is provided a method of dynamically triggering the availability of an offer for display on a client device, the method comprising:
a) obtaining a set of offers, at least one offer of said set of offers having associated therewith one or more extrinsic offer trigger parameters and triggering logic, the extrinsic offer triggers parameters being dependent on extrinsic user context information;
b) obtaining the extrinsic user context information for evaluating the extrinsic offer triggers parameters; and
c) processing the triggering logic and the offer trigger parameters and identifying a set of triggered offers for which the triggering logic is satisfied; and
d) activating the set of triggered offers, such that the set of triggered offers may be displayed on a client device.

In another aspect, there is provided a method of preparing a dynamically triggerable deal for display on a client device, the method comprising:
a) providing offer data defining an offer;
b) providing one or more offer trigger parameters, the offer trigger parameters being dependent on user context information associated with a user of the client device; and
c) providing triggering logic for determining, based on the offer trigger parameters and the context information, when a customized offer is to be activated.

In another aspect, there is provided a computer readable medium for storing executable instructions, which, when executed in a processing system, cause said processing system to perform a method comprising:
a) obtaining user context information associated with the user;
b) obtaining, a set of valid offers that are associated with the user context information;
c) processing the set of valid offers and the user context information to identify a set of matching offers that is relevant to the user; and
d) processing the set of matching offers and the user context information according to offer prioritization rules to obtain a prioritized subset of the matching offers for display on a client device associated with the user.

In another aspect, there is provided a computer readable medium for storing executable instructions, which, when executed in a processing system, cause said processing system to perform a method comprising:
a) obtaining a set of offers, at least one of said set of offers having associated therewith one or more customized offer trigger parameters and triggering logic, wherein the customized offer trigger parameters are dependent on user context information associated with a user;
b) obtaining the user context information and evaluating the customized offer trigger parameters for each offer; and
c) processing the triggering logic and the customized offer trigger parameters, and dynamically triggering a matching offer when the triggering logic is satisfied.

In another aspect, there is provided a computer readable medium for storing executable instructions, which, when executed in a processing system, cause said processing system to perform a method comprising:
a) obtaining a set of offers, at least one offer of said set of offers having associated therewith one or more extrinsic offer trigger parameters and triggering logic, the extrinsic offer triggers parameters being dependent on extrinsic user context information;
b) obtaining the extrinsic user context information for evaluating the extrinsic offer triggers parameters; and
c) processing the triggering logic and the offer trigger parameters and identifying a set of triggered offers for which the triggering logic is satisfied; and
d) activating the set of triggered offers, such that the set of triggered offers may be displayed on a client device.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 is a block architecture diagram illustrating the architecture of the system in accordance with an embodiment of the disclosure;

FIG. 2b is a schematic diagram of an example back-end system;

FIG. 2c is a schematic diagram of an example client device;

FIG. 3a is a block diagram illustrating how various users, merchants, and administrators may access the back-end system.

FIG. 3b is a block architecture diagram illustrating an alternative embodiment in which a client device includes an application for client-side offer processing.

FIG. 4a is a flowchart illustrating the consumer flow in accordance with exemplary operation of an embodiment of the disclosure;

FIG. 4b is a flowchart illustrating the difference in functionality accessible for a logged-in user versus a non-logged-in user in accordance with exemplary operation of an embodiment of the disclosure;

FIG. 5a is a flowchart illustrating the offer data publishing logic in accordance with exemplary operation of an embodiment of the disclosure;

FIGS. 5b-5f are example screenshots illustrating the process of offer creation and publishing via a merchant interface;

FIG. 5g is a flowchart illustrating the real-time offer delivery in accordance with exemplary operation of an embodiment of the disclosure;

FIG. 6a is a flowchart illustrating the administration flow in accordance with exemplary operation of an embodiment of the disclosure;

FIGS. 6b-6h are example screen shots illustrating various merchant interactions with the system;

FIG. 7 is a flowchart illustrating the client application flow in accordance with exemplary operation of an embodiment of the disclosure;

FIG. 8a is a flowchart illustrating the process of the client application and back-end system integration to enable real-time data and data updates in accordance with exemplary operation of an embodiment of the disclosure;

FIGS. 8b-8d are example screenshots illustrating the process of selecting categories and preferences via a client application.

FIG. 9a is a flowchart illustrating the offer prioritization mechanism in accordance with exemplary operation of an embodiment of the disclosure;

FIG. 9b is a flowchart illustrating the overview of dynamic offer process in accordance with exemplary operation of an embodiment of the disclosure

FIG. 9c is a flowchart illustrating the system dynamic offer evaluation process in accordance with exemplary operation of an embodiment of the disclosure;

FIGS. 9d and 9e illustrate parameters that may be selected to configure a collection of dynamic offers for a merchant (FIG. 9e is a continuation of FIG. 9d, such that the second to ninth columns of FIG. 9d are intended to be appended to the end of the columns in FIG. 9d in order to provide a single table);

FIGS. 10a-10j illustrate an example process of creating, publishing, and delivering a dynamic offer.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure. It should be understood that the order of the steps of the methods disclosed herein is immaterial so long as the methods remain operable. Moreover, two or more steps may be conducted simultaneously or in a different order than recited herein unless otherwise specified.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

Unless defined otherwise, all technical and scientific terms used herein are intended to have the same meaning as commonly understood to one of ordinary skill in the art. Unless otherwise indicated, such as through context, as used herein, the following terms are intended to have the following meanings.

As used herein, the term “network” may be understood to refer to one or more communication channels that enable communication between entities. For example, the term network may include one or more wired or wireless communication channels used to implement one or more local area networks (“LANs”), wide area networks (“WANs”), the Internet, virtual private networks (“VPNs”), intranets, extranets, or combinations thereof. Non-limiting example wireless networks may implement 3G and 4G mobile communications, Wi-Fi LANs, and Bluetooth connections. Exemplary wired networks can include dial-up, cable, digital subscriber line (DSL), integrated services digital network (ISDN), and Ethernet technologies, among others. A network may include devices such as routers, hubs, and switches, as well as endpoints (e.g., clients and servers) that communicate over the network.

As used herein, the term “server” refers to any computing system or device configured to receive and respond to requests made over a network from one or more computing system or device, such as clients.

As used herein, the term “client” refers to any computing system or device capable of being configured to communicate with a server made over a network.

As used herein, the term “server application” refers to an application implemented on a server.

As used herein, the term “client device” refers to a computing device on which an application runs that utilizes network communication. Furthermore, a client device may be sometimes referred to as an “end device”, “consumer device”, “end-client device”, or simply “destination device” as the application on the client device is the end recipient of a network communication in some scenarios. The client device also is sometimes referred to as a “mobile device” as the client device may be portable in some scenarios, such as when the client device comprises, for example, a mobile phone, smartphone, tablet, laptop computer, notebook computer, or other portable computing device.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net, HTML-5, and the like. Browsers, email clients, text messaging clients, calendars, and games are examples of client applications. A mobile client application refers to a client application that runs on a mobile device.

As used herein, the term “mobile client application” refers to a client application that runs on a mobile device.

As used herein, the terms “module,” “modules”, “function”, and/or “algorithm” generally refer to, but are not limited to, a software and/or hardware component that performs certain tasks. A module may advantageously be configured to reside on an addressable storage medium and be configured to execute on one or more processors. A module may be fully or partially implemented with a general purpose integrated circuit (IC), co-processor, field-programmable gate array (FPGA), or application-specific integrated circuit (ASIC). Thus, a module may include, by way of example, components, such as software components, object-oriented software components, class libraries, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or be further separated into additional components and modules. Additionally, the components and modules may advantageously be implemented on many different platforms, including computers, computer servers, computing devices, client device s, data communications infrastructure equipment. In any of these cases, implementation may be achieved either by writing applications that are native to the chosen platform, or by interfacing the platform to one or more external application engines.

As used herein, the term “user” refers to a consumer to whom offers or deals are communicated. A “user” may also be a business or other entity to whom offers are communicated, for example, in a business-to-business scenario.

As used herein, the terms “deal” and “offer” refer to a marketing promotion or offer, in electronic form, deliverable to, and displayable on, a client device. An offer may be available to the general population, to all users, and/or to a subset of users. In some embodiments, offers are communicated to users, who are consumers who receive the offers on a client application.

As used herein, the terms “real time” or “near real-time” refer to action that is implemented immediately, or approximately immediately (for example, within seconds), relative to an event (such as a request or determination that the action should be executed).

As used herein, the phrases “dynamic deal” and “dynamic offer” refer to an offer for which availability to one or more users may be triggered or activated based on one or more rules or logic conditions.

As used herein, the term “triggered offer” (or simply “triggered”) or “activated offer” (or simply “activated”) refers to a dynamic offer that is active and can potentially be viewed by users.

As used herein, the term “offer trigger parameters” or “trigger parameters” refers to parameters of dynamic offers that are processed when evaluating triggering logic associated with the offer.

As used herein, the term “triggering logic” refers to one or more logical conditions associated with offer trigger parameters, which, when satisfied, causes an offer to become available to users (if any) who satisfy triggering logic associated with the offer.

As used herein, the term “offer customization trigger parameters” or “customization triggers” refers to consumer-related trigger parameters of a dynamic offer which may be valid for a given consumer A, and not for another consumer B, who's consumer context is otherwise the same or similar to consumer A.

As defined herein, the term “trigger data” refers to all trigger data for a dynamic offer (offer trigger parameters and offer customization triggers).

As defined herein, the term “personalized offer” or “personalized dynamic offer” refers to a triggered instance of a dynamic offer for which the processing of offer customization triggers has been employed to generate and display the proper specific offer to a particular user.

As used herein, the terms “merchant” and “retailer” refers to an individual, business entity, retail chain head office, franchise, distributor, wholesaler, or other organization with goods or services to sell or offer to another party, either directly or indirectly. In one example, the other party is a consumer. In another example, in a business-to-business related scenario, the other party could be another business.

As used herein, the term “user location” refers to the user's geographic location. For example, the user location can be determined by the device application programming interfaces (API's) associated with a client device in order to obtain the user location based on geo-location data from the device location subsystem (which may use, for example, GPS, Wi-Fi, cellular, or other location determination mechanisms). In some example implementations, such as in the event that user location information cannot be obtained from the client device in an automated fashion, the system may use the default or user-set location information (which may be based on location selections or inputs, such as city, zip, postal code, etc.).

As used herein, the term “prioritized view” refers to the view on the client application which displays offers in a manner personalized for the user based on their user context information. This view can be customized by way of categories, sequence, colour, or other mechanism such that higher ranking offers are differentiated from lower ranking offers. “Prioritized view” may also be referred to as “My Deals”.

As used herein, the term “prioritized subset” refers to a subset of deals which are prioritized for display on the client device, for example, in a prioritized view.

As used herein, the term “offer data” refers to the data entered by merchants for initiating, describing, and classifying offers. Each offer may have several attributes associated with it, including but not limited to title, description, image, fine-print, publish date/time, start date/time, and end date/time.

As used herein, the term “publish pool” refers to the offers which are available to be sent to and displayed on a client device. According to one embodiment, an offer can be placed in the publish pool if the current time is within its publish window (current time must be greater than or equal to offer publish time, and must be before offer end time), and is not marked as deleted. The placement of an offer in the publish pool may be governed by other factors, for example, in one embodiment, the merchant related to the offer must have their registration and account in good standing. The publish pool may be implemented as an actual flagging or storage of offers. In other embodiments, the term “publish pool” may relate to offers that are able to be published to client applications, according to a wide variety of implementations.

As used herein, the term “distance preference” refers to the user's distance preference, defining the range distance range relative to their location, for which the user is willing to receive offers. This distance range can be employed to filter and/or prioritize offers.

As used herein, the term “my deals” refers to the application function which displays the prioritized view of available offers based on the user context.

As used herein, the terms “offer prioritization” and “offer prioritization” refer to the prioritization of offers such that the offers are ranked and displayed according to priority and/or ranking.

As used herein, the terms “deal prioritization rules” and “offer prioritization rules” refer to logic for determining, according to prioritization parameters, the rank of one or more offers belonging to a prioritized subset of offers.

As used herein, the terms “dynamic deal prioritization” and “dynamic offer prioritization” refer to the ranking rules outside of user-control, which are stored in the back-end system and which can be changed at any time by system administrators with results reflected in near real-time on the client device screen output

As used herein, the term “rank” refers to an internal system score allocated to a given deal or offer based on its matches and rating received by the matching engine.

As used herein, the term “offer delivery” refers to the process used to deliver and update offers on the client application. Via this process, the client application will be updated with the latest offer information. The process may include the adding, updating, or removal, of offers from the client application, based on the valid offers available, and the user context.

As used herein, the term “alert” refers to alerting of the user by some means, such as a text-based notification, to the availability of one or more offers which have been determined by the matching engine to require an alert by the alert mechanism. This may be done by a change in the application icon, an icon count, icon new-data indicator, and/or by sound, and/or by physical device vibration, or by other means depending on client device capabilities, client device settings, and user preferences.

As used herein, the term “valid offers” refers to those offers which match the user context information.

As used herein, the term “offer sort and filter” refers to a processing step in which the matching engine is employed to perform the sorting and filtering of offers based on the offer profile and offer prioritization rules.

As used herein, the term “offer management system” refers an example subsystem of the back-end system that is employed to manage the offers. In some embodiments, this subsystem can be accessed by the authenticated merchant and system administrators.

In some embodiments of the present disclosure, systems and methods are provided for the targeted delivery and prioritized display of advertising offers, marketing promotions, and/or offers (also referred to as “deals”) to users over a network, based on user context information.

User context information, as used herein, may refer to any or all known information that is associated, directly or indirectly, with a user. For example, “user context information” may include, but is not limited to, items such as: user settings and/or preferences (including an “offer profile” or “deal profile”, described further below), geographic location, distance preference, keywords, merchant ratings, preferred/favourite merchants, user id, user registration information, subscription status, offer sort preference, loaded offers, offer ranking preferences, previous actions, environment information associated with the location of the user, such as (weather, date, time, etc.), previous system usage, location data (position, movement, history, etc.).

One example of user context information is user preference information that may include information pertaining to, for example, the likes, wants, and/or needs, of a user. One type of user preference information is offer prioritization information, which may be provided by a user to define the types of offers that the user would like to receive, and information pertaining to how the offers are to be prioritized in the client application's view of all offers available. In the embodiments below, such offer prioritization information is referred to as a “offer profile”. An offer profile may include information that enables the display and alerting of offers (for example, on an ongoing real-time basis) to be provided in a prioritized manner. The offer profile may include, but is not limited to: category subscriptions and optional key-words, and prioritization information such as category prioritization, ranking variables used, and ranking settings.

By providing user context information in the form of an offer profile, or other suitable form, the system may provide targeted offers, or notifications of offers, in real-time, where the offers are provided according to, and are optionally ranked according to, the user preference information provided in the offer profile. Accordingly, by directing an offer to users that are likely to be receptive to an offer due to their own expressed interest, the merchant can tend to be better assured that the marketing promotion is received by users that have indicated on their profile that they wish to receive such promotions and who are therefore more likely to act on them.

User context information may also include user data obtained or obtainable from external sources, such as, but not limited to, social media platforms, other vendor websites, internet searches, credit rating agencies, and online information regarding other users associated with the user.

The preceding examples of user context information are examples of intrinsic user context information, which is user context information that pertains intrinsically to the user. Another form of information that may be employed to trigger the availability of a dynamic offer is extrinsic user context information, which is context information that, does not related directly to the user, but, for example, when coupled with intrinsic user context information, may be employed to deliver offers in a targeted form.

Examples of extrinsic user context information include the weather, recent news information, and the time. For example, by coupling the current weather with the user's location, an offer relating to snow tires may be delivered when the first snowfall of the season occurs at the user's location. In another example, offers pertaining to a security system may be delivered to a user when a news item appears online relating to a burglary within a specified distance of a user's home. In another example, by coupling the current time with a user's interest to obtain offers related to dinner, offers may be provided to the user in the afternoon, when the user is likely to be hungry and interested in dinner. In each of these examples, intrinsic user information is coupled with extrinsic user context information to trigger the delivery of an offer to a user. Embodiments for implementing such methods are described in further detail below.

Some embodiments of the present disclosure therefore enable a merchant to define an offer (for example, through a merchant interface) such that the offer is delivered to users in real-time, where the offer is provided based on user context information. This and other aspects of the disclosure may enable merchants to capitalize on marketing opportunities in real-time, where the offers are delivered to users on a targeted basis.

Accordingly, in some embodiments, the systems and methods disclosed herein may be employed by merchants to:
a) rapidly create offers of varying duration (from minutes to days);
b) deliver promotions to be delivered to the user's client device in real-time, or at a specified future offer publish date and time;
c) target offers specifically to types of users (for example, to high-value target users) who are known to be very likely to welcome the advertising message as it applies to their current needs, wants, likes, preferences, context, situation or other information;
d) immediately publish/enable or cancel/disable an offer at any time;
e) allow users to (i) define a profile including user context information such as their likes, wants, needs, ranking preferences, etc., (ii) update the profile at any time, and (iii) be alerted to, and/or view, offers that are relevant specifically to their user context information, in a personalized offer view;
f) access aggregate real-time data or historical data on profiles of users in a specific geographical boundary, which can then be used to better target promotions; and
g) creating dynamic logic or rule-based offers, which are triggered according to triggering logic (involving offer trigger parameters) for triggering the offer when the logic is satisfied.

These and other embodiments of the present disclosure are described in further detail below.

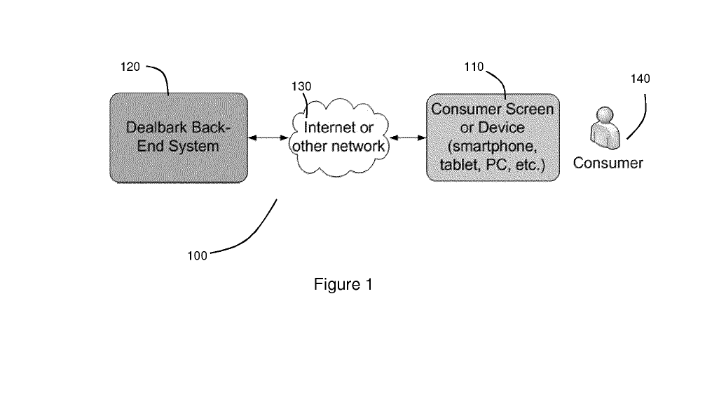

Referring to FIG. 1, there is depicted an example system 100 that provides real-time delivery of marketing promotions to users according to user context information. System 100 includes a client device 110 and a “back-end” computing system or server 120, which communicate via network 130. In some embodiments, users (erg, consumer 140) interact with the back-end system 120 via a user interface that may be a consumer-facing public web-site (from an application or web-based, for example), or through a specialized user interface (e.g. an app) as described below.

Back-end system 120 facilitates the delivery of the offers to the client device 110 based on user context information, and as needed to ensure rapid display upon user offer profile change. Back-end system 120 also supports the processing and delivering offers in real-time, and to allow the user to set an offer profile to drive what types of offers they will have in their prioritized view, with their associated ranking. Client device 110 can display the prioritized offers based on the user context, and thus highlight and optionally alert the user via various means, for the user those promotions which are deemed worthy of their user context.

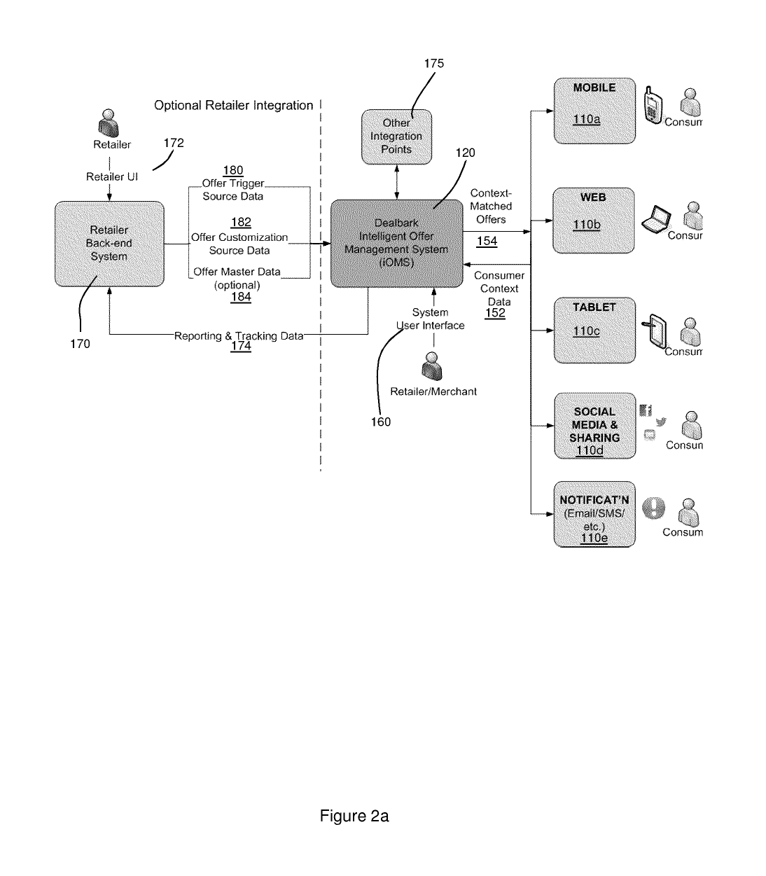

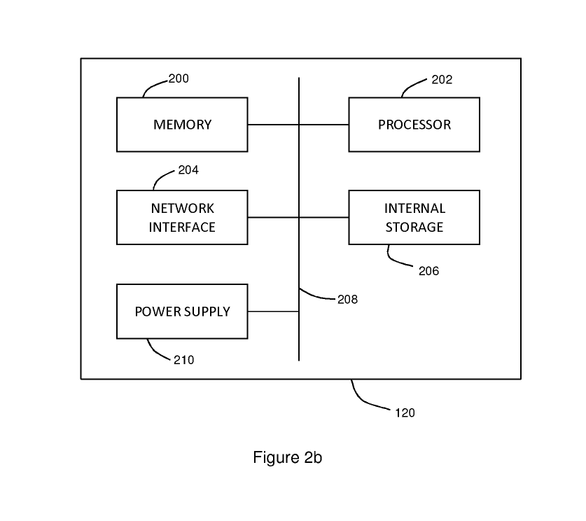

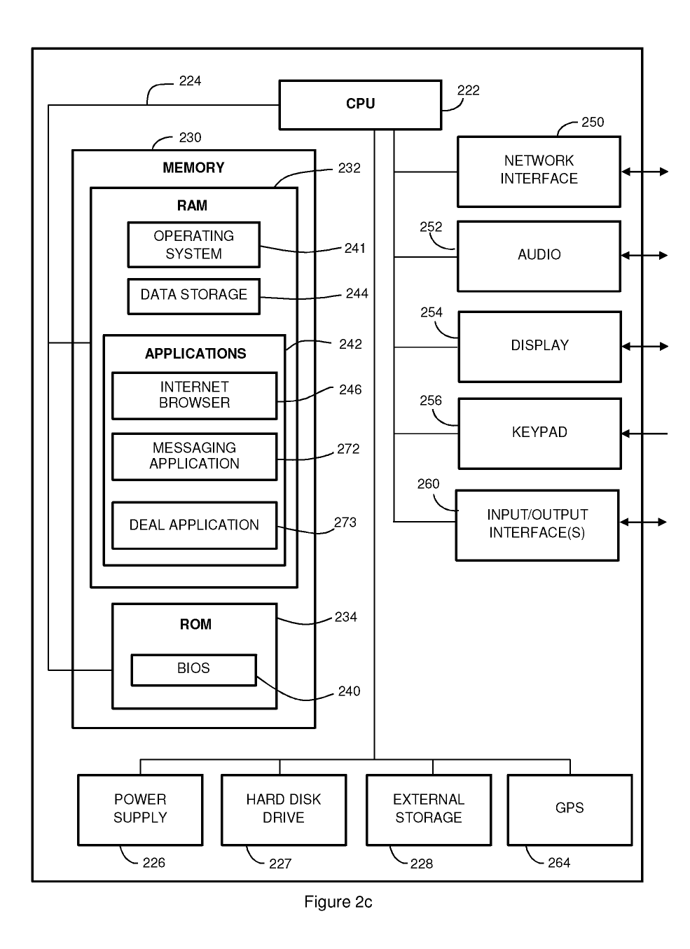

FIG. 2 illustrates how other stakeholders may access the system for a variety of purposes. Users may access the back-end system, and receive offers from the back-end system, using any one or more of a wide variety of client devices, such as a mobile smartphone or other communications device 110a, a web browser 110b on a computing device such as a PC, laptop or netbook, a tablet 110c, and through a social media interface 110d and/or through notifications 110e (such as email and text message notifications). User context information is provided by the user to back-end system 120 over a network, as shown at 152, and in back-end system delivers relevant offers to users, as shown at 154 (“context matched offers”).

Merchants may access back-end system 120 through a user interface 160, which may be a web portal, or a separate app that resides on a merchant computing device. In some embodiments, back-end system 120 may be accessed and used by a merchant to define, determine, manage, report on, and deliver the promotions to end-users (consumers in a business-to-consumer scenario, or other merchants in a business-to-business scenario), as well as to update merchant profile information, and to get reports on past, present, and future offers, and on user profile data.

Merchants may interact with the back-end system 120 via a merchant user interface 160, which may be a web portal (e.g. a merchant-facing web site). Back-end system 120 includes modules/subsystems to permit merchants to input and store offers, which are described in further detail below. Merchant user interface 160 and/or an additional user interface, may provide administration functionality for controlling and managing back-end system 120. The user interfaces may access back-end system by via a local or wide area network (such as the internet).

In addition, back-end system 120 may be further integrated with additional integration points 175, for providing other modes of access to the system, and/or for obtaining additional information for use in processing triggering logic associated with offer triggering. For example, the additional integration points may be sources of extrinsic user context information, such as, but not limited to, news websites, weather websites, and social media websites.

The example system shown in FIG. 1b may be employed to provide targeted offers to users, in real-time, based on one or both of intrinsic user context information and extrinsic user context information. For example, a merchant may wish to deliver an offer to advertise a service or product in real-time to a potential customer, where the potential customer has an interest in purchasing the service or product. For example, a merchant may wish to advertise a set of snow tires to local customers in the market for snow tires immediately, such as during a first snow-fall in the season at a particular location/area. The merchant inputs the offer to back-end system 120. Back-end system 120 communicates with client device 110 (which may run a client application, as described below) over the internet via network connection 130 in real-time to obtain intrinsic user context information that includes a location of the user. Back-end system 120 also obtains weather information associated with the user's location. The weather information may be obtained via an external source, such as a weather information website, with which back-end system 120 communicates to obtain the weather associated with the user's location. Business logic rules are then employed to process the weather to determine whether or not the first snowfall of the season is occurring. In such a case, an offer pertaining to snow tires is delivered to, and displayed on, the user's client device 110.

FIG. 2a also illustrates an embodiment in which a retailer back-end system 170 may be interfaced with back-end system 120. Retailers may access retailer back-end system through retailer user interface 172, for receiving reporting and tracking data 174 from back-end system 120. Additionally or alternatively, retailer back-end system may communicate with back-end system 120 for providing data for the triggering of offers 180, data for the customization of offers 182, and offer master data 184. Offer master data 184 may include data such as offer headlines, descriptions, images, publish and start/stop dates and times, categorizations, applicable locations and/or other offer data which could be provided to the system to create offers or aid in creating offers.

As shown in FIG. 2b, back-end system 120, is a computing system, such as a server, which includes at least a memory 200, processor 202, system bus 204, network interface 206, internal storage 208, and power supply 210. Back-end system 120 may include one or more additional subsystems. Example additional subsystems include external storage, web servers, and other suitable hardware. Although back-end system 120 is shown as a single computing system, it is to be understood that back-end system may be implemented as one or more computing devices that are connected or networked together to provide the required functionality and/or resiliency/redundancy.

In one embodiment, back-end system 120 manages accounts for users to allow the users to store various forms of information, including user context information, user account information, and payment information such as payment cards (e.g. debit and/or credit card). In one embodiment, back-end system 120 allows users to link their social networking accounts with their account on the central servers or accounts on other social networks.

As noted above, client device 110 can take on a variety of forms. FIG. 2c illustrates an example embodiment of client device 110, which may be a mobile client device. Client device 110 includes a processing unit (CPU) 222 in communication with a mass memory 230 via a bus 224. Client device 110 also includes a power supply 226, one or more network interfaces 250, an audio interface 252, a display 254, a keypad 256, an input/output interface 260, and an optional global positioning systems (GPS) receiver. Power supply 226 provides power to client device 110. A rechargeable or non-rechargeable battery may be used to provide power. The power may also be provided by an external power source, such as an AC adapter or a powered docking cradle that supplements and/or recharges a battery.

Client device 110 may optionally communicate with a base station (not shown), or directly with another computing device. Network interface 250 includes circuitry for coupling client device 110 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images.

Client device 110 also comprises input/output interface 260 for communicating with external devices, such as a headset, or other input or output devices not shown in FIG. 1. Input/output interface 260 can utilize one or more communication technologies, such as USB, infrared, Bluetooth™, Wi-Fi, Zigbee, or the like.

Optional GPS transceiver 264 can determine the physical coordinates of client device 110 on the surface of the Earth, which typically outputs a location as latitude and longitude values. GPS transceiver 264 can also employ other geo-positioning mechanisms, including, but not limited to, triangulation, assisted OPS (AGPS), E-OTD, CI, SAI, ETA, BSS or the like, to further determine the physical location of client device 110 on the surface of the Earth. It is understood that under different conditions, GPS transceiver 264 can determine a physical location within millimeters for client device 110; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

In one embodiment, GPS transceiver 264 may operate with one or more other components of client device 110 to connect to a network, to provide location information to another computing device.

It should be noted, that where the user's configuration includes a GPS or other location detection device that is separate from client device 110, then that device may also include, in one embodiment, an ability to connect to a network to provide location information to another computing device.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 110. The mass memory also stores an operating system 241 for controlling the operation of client device 110. It will be appreciated that this component may include a general purpose operating system such as a version of UNIX, or LINUX™, or a specialized client communication operating system such as iOS™, Android™, Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 110 to store, among other things, applications 242 and/or other data. For example, data storage 244 may also be employed to store information that describes various capabilities of client device 110. The information may then be provided to another device based on any of a variety of events, including being sent as part of a header during a communication, sent upon request, or the like. Moreover, data storage 244 may also be employed to store personal information including but not limited to address lists, contact lists, personal preferences, or the like. In one embodiment, data storage 244 may be configured to store information, including, but not limited to user account information, vendor information, social network information, or the like. At least a portion of the information may also be stored on a disk drive or other storage medium within client device 110, such as hard disk drive 227, external storage device 228, or the like. In one embodiment, a portion of the information may also be located remote to client device 110.

Applications 242 may include computer executable instructions which, when executed by client device 110, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VoIP applications, contact managers, task managers, transcoders, database programs, word processing programs, security applications, spreadsheet programs, games, search programs, and so forth. Applications 242 may also include browser 246, and messenger 272.

Browser 246 may be configured to receive and to send web pages, forms, web-based messages, and the like. Browser 246 may, for example, receive and display (and/or play) graphics, text, multimedia, audio data, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Messenger 272 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 272 may be configured as an IM application, such as AOL Instant Messenger, Yahoo! Messenger, .NET Messenger Server, ICQ, or the like. In one embodiment messenger 272 may be configured to include a mail user agent (MUA) such as Elm, Pine, MH, Outlook, Eudora, Mac Mail, Mozilla Thunderbird, or the like. In another embodiment, messenger 272 may be a client application that is configured to integrate and employ a variety of messaging protocols. In one embodiment, messenger 272 may employ various message boxes to manage and/or store messages.

As described further below, a deal application 273 may reside on client device 110, which may perform operations related to the storage, prioritization, ranking and display of offers on client device 110. Alternatively, such processing may be performed primarily or exclusively on back-end system 120, and where the user interacts with back-end system 110 via a thin client such as browser 246.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices.

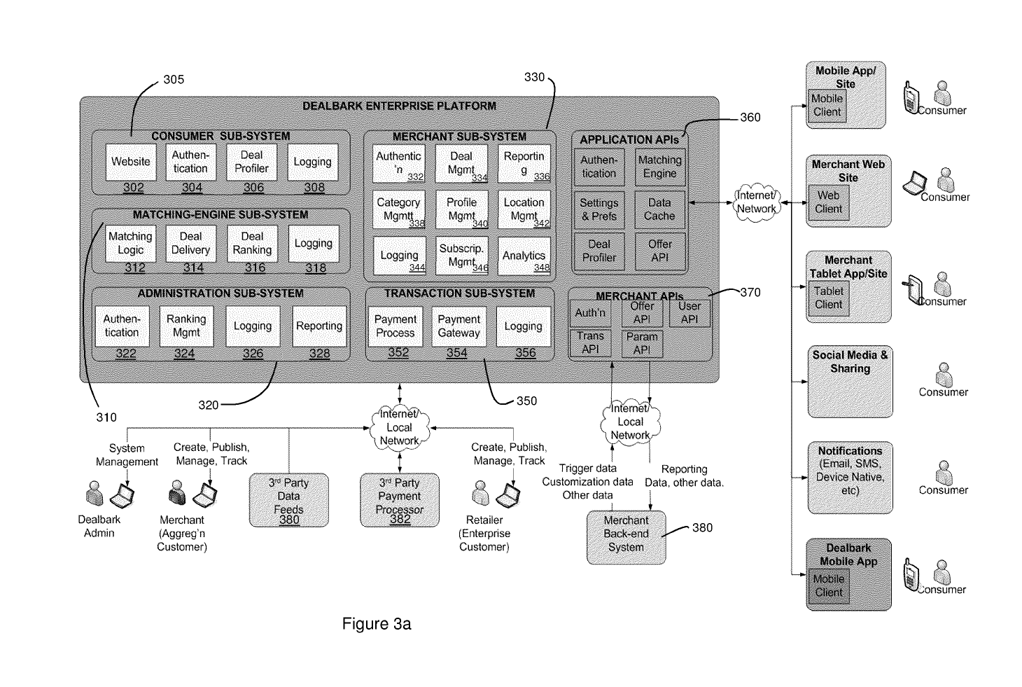

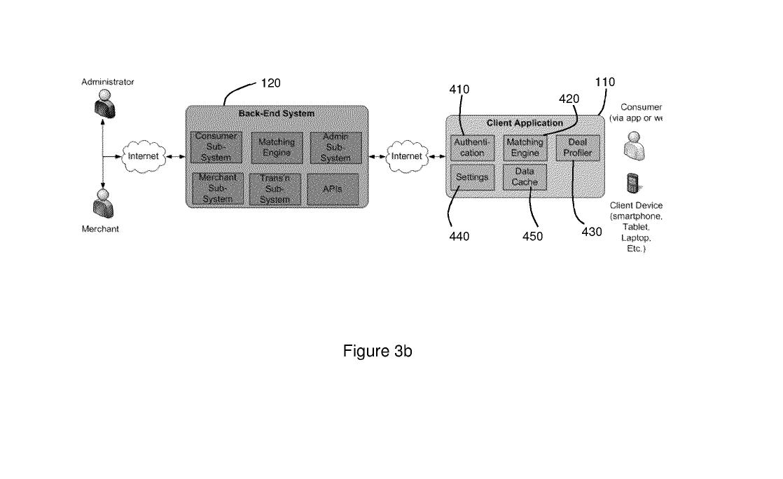

Referring now to FIG. 3a, a detailed block diagram of an example system is provided, in which the various optional modules of back-end system 120 are shown. According to this example embodiment, at least a portion of the processing of offers is performed on back-end system 120, and further processing is optionally performed on a user device.

The consumer sub-system 305 contains data and functionality related to the authentication of consumers and the processing of consumer data.

The website process 302 allows the user to interact with the consumer subsystem in both a non-logged mode in public website, and a logged mode. The logged-in mode allows the consumer to manage their profile and access some offer data similar to offer data accessible on the smart-phone.

The authentication subsystem 304 allows users to log in to the system securely and access data and functionality pertaining to them.

The deal profiler subsystem 306 allows the user to manage his or her offer profile. In one embodiment, the deal profiler subsystem 306 allows the user to incorporate items the user wants to see, or wants prioritized, as well as allows the user to add keywords (optionally associated with a category) and set a merchant as a preferred ‘favourite’ merchant. As described further below, this functionality may be duplicated in an application running on a client device.

Deal profiler 306 may be updated by the user, and any changes can take effect immediately and can be reflected on the user's personalized and prioritized view of offers (described further below as “Prioritized View” or “My Deals”). Deal profiler 306 may be a dynamic list of categories and keywords, and ranking settings which the user can select from, type in, or otherwise set and which the matching engine uses to filter, process, and prioritize for display, the valid offers available. These are then displayed in the prioritized view area/function of the client application, and processed by the alert mechanism for potential alert.

The logging process 308 allows for the execution, actions, and changes for each of the subsystems in the consumer subsystem 300 for audit and analytical purposes.

Example system 120 also includes matching engine sub-system 310, which contains deal matching logic subsystem 312, the deal delivery subsystem 314, the deal ranking subsystem 316 and the logging process 318. Matching engine sub-system 310 is programmed to perform the following tasks: 1) providing the relevant offers to users based on user context information; and 2) sorting, filtering, ranking, and organizing the offer data for display. In some embodiments, the latter task is implemented by matching engine code in an application that runs on a client device.

Matching engine sub-system 310 thus enables the system to process a user's context, i.e. items such as offer profile, location, distance preferences, favourites, and other ranking data, as well as any dynamic offer triggering rules, in order to select and display the appropriate offers of most interest to the user in a prioritized manner.

The deal profiler can be configured by the user to define their current likes, wants, needs, and ranking preferences, thus enabling a prioritized offer display to the user. The offers/promotions the user sees in the client application prioritized view can thus continuously delivered to, and prioritized in display for, users who are more likely to be interested to the promotion given their current user context. In some embodiments, offer data is continuously updated in real-time for the user based on their user context information and deal profile.

Deal matching logic subsystem 312 may contain matching logic to determine which deals to display to a user based on their user context information, as defined above, and shown in the examples below. Deal matching logic subsystem 312 may also contain logic to determine whether to alert the user based on the available deal matches and the user context information.

Deal delivery subsystem 314 may select available matching offers, as determined by deal matching logic module 312, and send the data to the appropriate client device.

Deal ranking sub-system 316 processes offer prioritization information, as provided by the user in the deal profile (or other user preference parameters), to rank offers available to a given user in their current user context information. This result of this processing determines how offers are prioritized and displayed for the user.

Logging process 318 allows for the logging of the execution, actions, and changes for each of the subsystems of the matching engine subsystem 310 for audit and analytical purposes.

Administration sub-system 320 in an example embodiment contains an authentication subsystem 322, a ranking rules management subsystem 324, a logging process 326, and a reporting subsystem 328.

The authentication subsystem 322 process enables administrators to log in to the system securely and access data and functionality pertaining to them. The ranking management subsystem 324 provides the ability to manage (create, modify, delete) ranking variables and manage the offer prioritization rules determining how offers are prioritized for users.

The logging process 326 allows for the execution, actions, and changes for each of the subsystems of the administration subsystem 320 for audit and analytical purposes. Reporting subsystem 328 is programmed to provide reports pertaining to system management and audit.

Merchant subsystem 330 is shown including an authentication subsystem 332, a deal management system 334, a reporting subsystem 336, a category management subsystem 338, a profile management subsystem 340, location management subsystem 342, logging subsystem 344, subscription management subsystem 346, and analytics and business intelligence subsystem 348.

Authentication subsystem 332 enables merchants to log in to the system securely and access data and functionality pertaining to them. Deal management subsystem 334 provides merchants with the ability to manage (e.g., create, modify, delete) offers, and to automatically publish offers to target users. An example of creating a deal via deal management subsystem is provided below.

Reporting subsystem 336, and the analytics & business intelligence subsystem 348, may provide the ability to view data and reports, which may, for example, include: number of users receiving offers; number of times offers have been viewed; number of times offers have been redeemed; and merchant and/or offer ratings. Reports may also be based on any given historical time period up to the current moment, or on data at the current time. Reported data may further include: keyword report on aggregate user count for each keyword in the system within a given category and/or geographic range; aggregate number of users within a given geographic area who have a given offer category selected. Data may be filtered by user attributes, such as age, sex, system usage history, or other attributes available. This data can then be leveraged by merchants to devise marketing plans for offers.

Category management subsystem 338 allows the merchant to: to request new category allocation, enabling offers to be created within that category. These offers may be alerted to a system administrator, for approval of the request, and if required, the system administrator may create new categories before any offers can be created by the merchant within any newly selected categories.

Profile management subsystem 340 provides the ability to manage the merchant master profile, which may include information associated with a merchant, such as main contact, email, phone number, main address, billing information and/or logo.

Location management subsystem 342 allows the merchant to manage their locations of their place of business. Such locations may then be optionally selected when configuring an offer, such that a given offer may be redeemed at a location. Using location management subsystem 342, merchants may add or remove locations. In general, at least one location will be provided by a merchant, such as a head office location.

Logging subsystem 344 provides a means for: logging of the execution, actions, and changes for each of the subsystems of the merchant subsystem 330 for audit and analytical purposes.

Subscription management and payment gateway module 346 allows the merchant to manage their payment or subscription, and may be configured to interface with outside payment processing systems.

Transaction sub-system 350 allows payments to be processed, both for merchant subscriptions, and for offers where the consumer can make an immediate purchase of the good or service. Payment may be processed using either by internally managed payment processing or by an interface to an external third-party payment processing service. The payment processing sub-system 352 can for example handle gathering of payment and tender data. The payment gateway sub-system 354 can act as an interface to pass and receive data to/from a 3^{rd} party payment processor service which could execute the transaction. All transaction processing would be logged via the transaction logging service 356.

Application APIs 360 provide application programming interfaces such that client applications can send and receive appropriate data to and from the system, such as authentication data, settings and preferences, deal profile data, context data, offer data, manage potential client application data caches, and so on.

Merchant APIs 370 provide application programming interfaces such that the merchant or retailer system can securely send or receive data related to: offers; the current values of offer trigger data (such as inventory levels, sales rates, weather, traffic patterns, or other data); the current values of consumer customization trigger data (such as consumer loyalty levels, purchase history, or other consumer related data); reporting; or other data to be transferred between the two systems.

3^{rd} Party Data feeds 380 optionally allow data such as weather, sports schedules, or any other data to come into the system.

3^{rd} Party payment processors 382 are third-party systems which provide the ability to process a payment and have it remitted to the appropriate authority. Examples of third-party payment processors include Paypal, Google Checkout, Visa V.me and similar services.

3^{rd} party branding, flyer, etc. are possible by the 3^{rd} party using the system APIs to transmit data to, and receive data from, back-end system 120. To enter data into the system, the merchant may authenticate and then enter data manually, or may transmit data using Merchant APIs. To transmit or receive data in any given application, the 3^{rd} party merchant can add application API calls to the their application, their middleware, or their back-end system 380. In this way, the third-party can provide, to a user, their own branded application user interface, providing relevant prioritized offers to their consumers, in addition to allowing visibility of a broad range of personalized, exclusive, public, or other offers or announcements.

Several non-limiting example architectures for integration are described as follows. In one example implementation, the system is hosted in a remote location shared instance configuration (shared amongst many merchants/retailers), and accessed by the merchant back-end system and client application via APIs. In another example implementation, the system is hosted in a remote location dedicated instance configuration (dedicated to a single merchant/retailer), and accessed by the merchant back-end system and client application via APIs. In another example implementation, the system could be installed as a fully internally hosted platform for a retailer, to manage for their exclusive use for their client applications and consumers.

As described above, back-end system 120 includes subsystems to allow input and storage of the consumer data, merchant data, and to allow system administration and processing of data, to provide administration functionality for merchant and system management, and to communicate offers to users. In some implementations, offer processing is performed on back-end system 120, with only the user-interface on the client device acting as a thin client (e.g. a web-browser via HTML or some similar markup or display method).

In another embodiment, offer processing, either in whole or in part, may also be implemented on client device 100. FIG. 3b provides a block diagram illustrating an example embodiment in which some of the modules that reside on back-end system 120, and some modules that may optionally reside on client device 110. For example, client device 110 may include an application that performs any one or more of modules shown in FIG. 2b, namely, an authentication module 410, a matching engine 420, a deal profiler 430, a settings module 440, and a data cache 450.

In the forthcoming disclosure, example embodiments are provided in which the client device includes and runs an application, such that a portion of the processing is performed on the client device, as shown in FIG. 3b above. It is to be understood that the example methods disclosed below could also be implemented, additionally or alternatively, by the back-end system, such that the client device is operated as a device for entering user input, rendering the display of offers and alerts, and communicating with the back-end system.

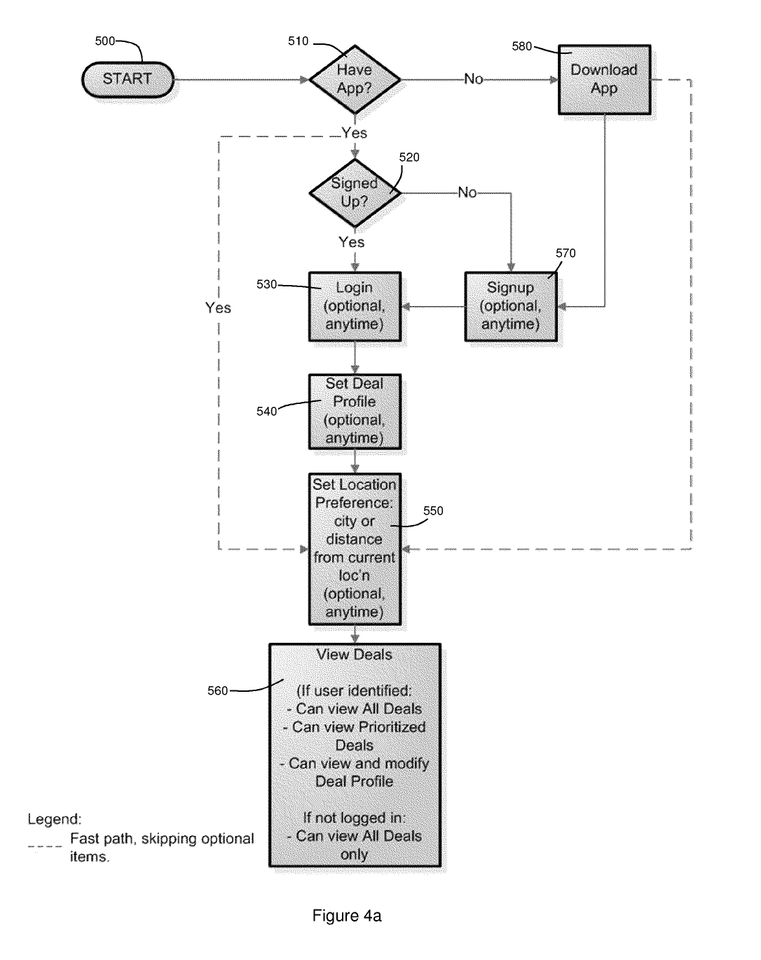

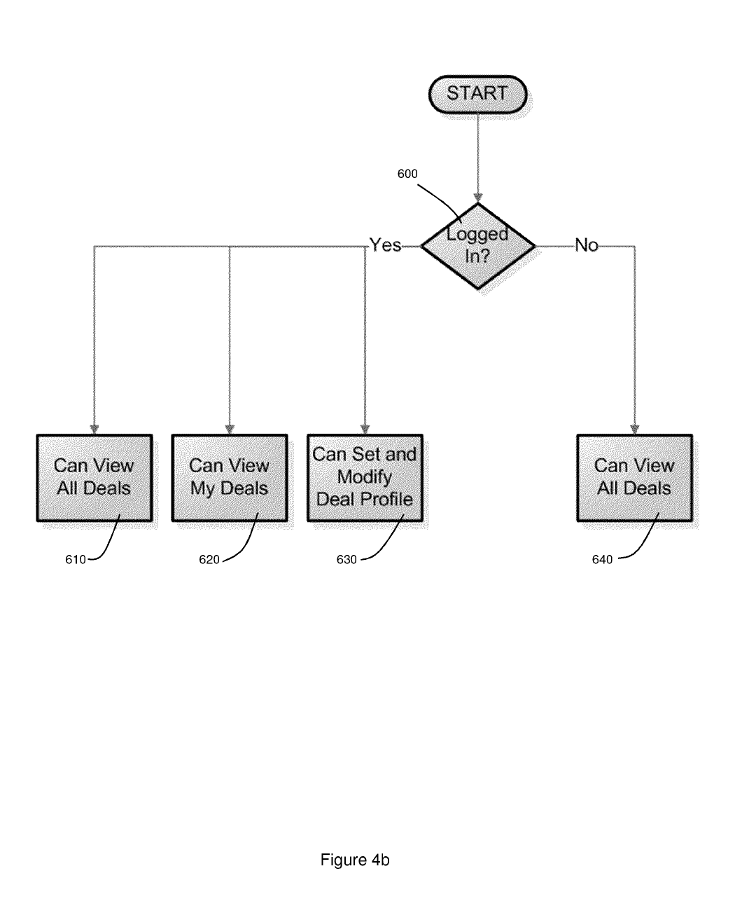

Referring now to FIG. 4a, a sample flow-chart is shown displaying the logic for the user's interaction with a sample client application. In one embodiment there are two options for the user: (a) a fast path not involving sign-up or login or (b) a path including sign-up and login.

The fast path involves the first-time user downloading or accessing the application 580, running the application, then updating location and/or distance preference 550, if desired, and browsing through all offers 560. In this option, the functionality dependent on user login (unique user identification) is not accessible. The functionality that can be dependent on user login includes the deal profiler 540, and display of the prioritized view 560. If, for example, the client application user is not logged in or otherwise identified because they are running the application for the first time, or the user has never logged in, or the user has logged out of the client application, the user may still view offers immediately by optionally setting location and/or distance preference 550,.

To log in to the application, the user must first register on the system (for example, via a web interface or on the client application 570). The user may log in 530 by inputting a unique identifier e.g. their selected email address and password to authenticate them on the system. Upon successful log-in, the user can access the functionality dependent on user login. This includes ability to access the deal profiler 540, and ability to display the prioritized view. The user may maintain the option to view the all offers listing in order to browse or search through all available offers.

FIG. 4b shows a flowchart of an example embodiment illustrating the difference in offer view functionality accessible for a logged-in user versus a non-logged-in user. A non-logged in user can only access all offers 640 whereas a logged-in user can access, for example, all offers 610, My Deals prioritized view 620, and can access the deal profiler 630.

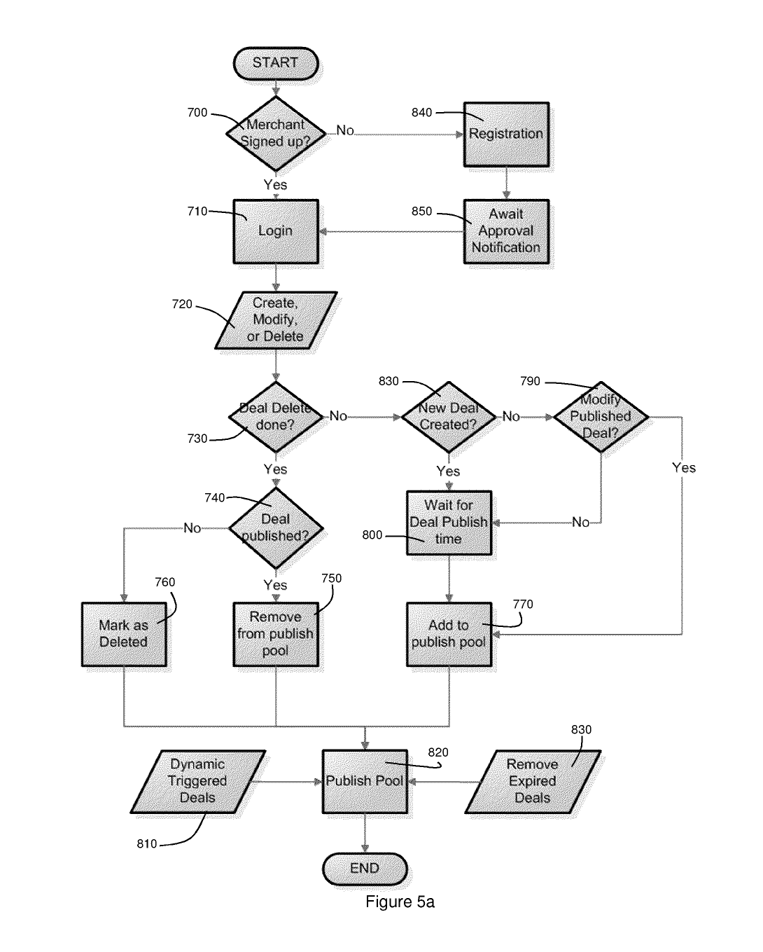

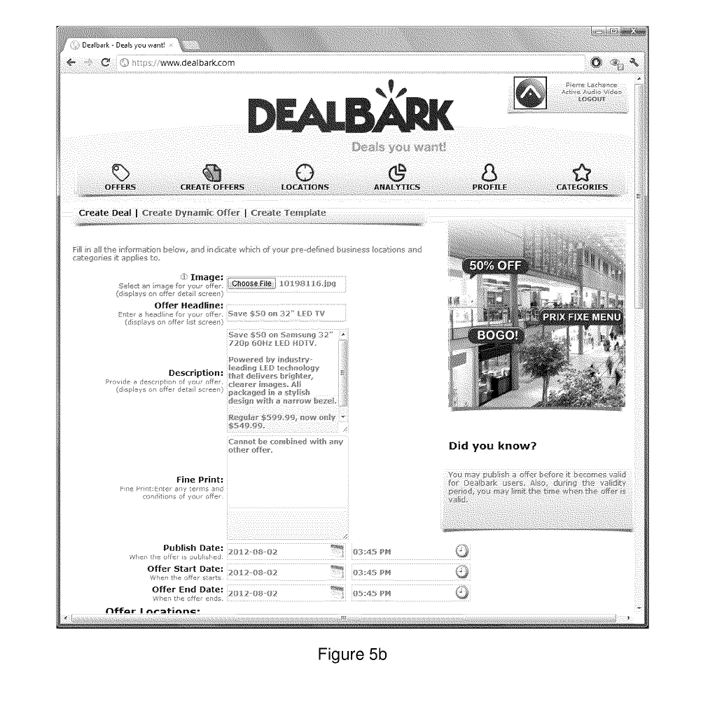

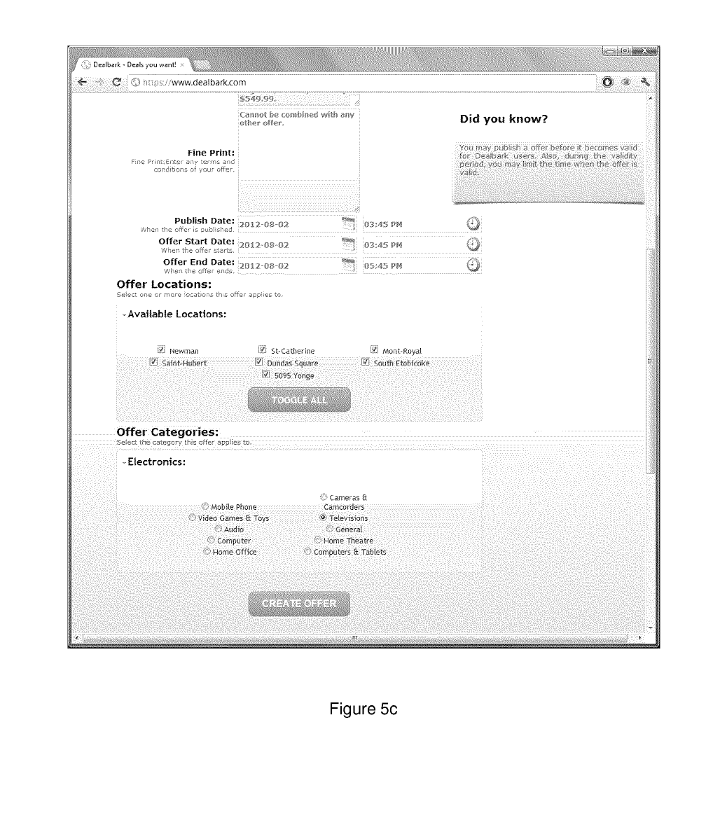

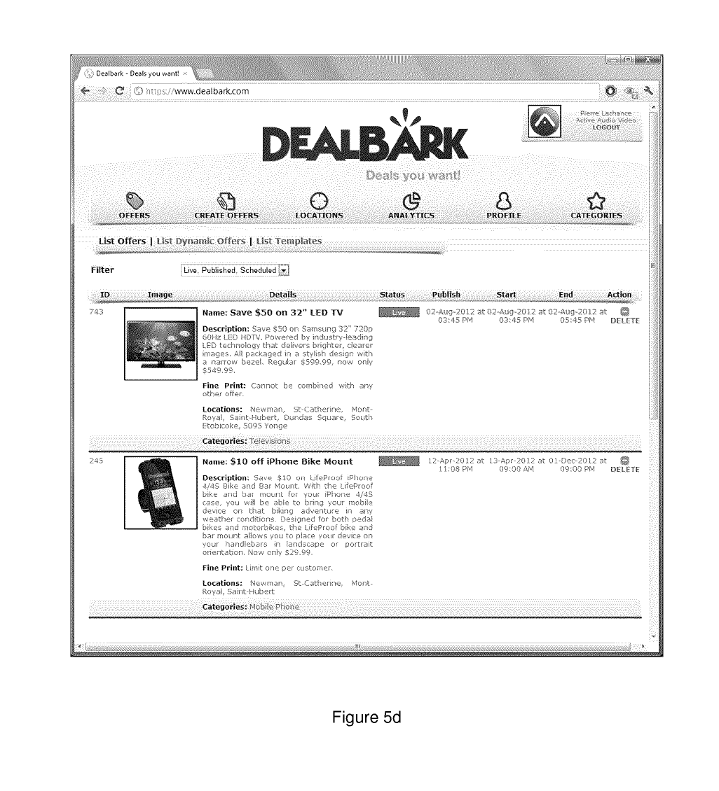

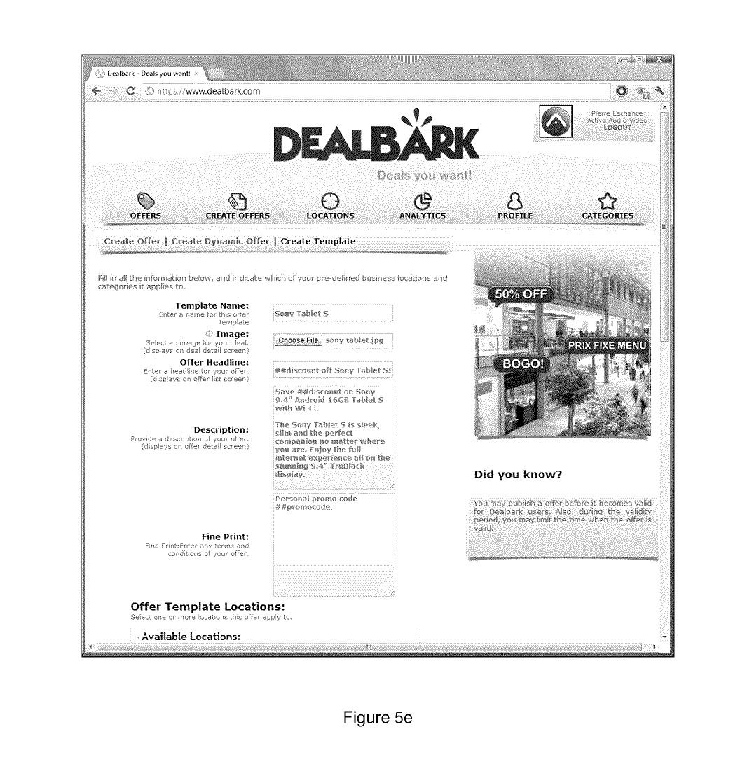

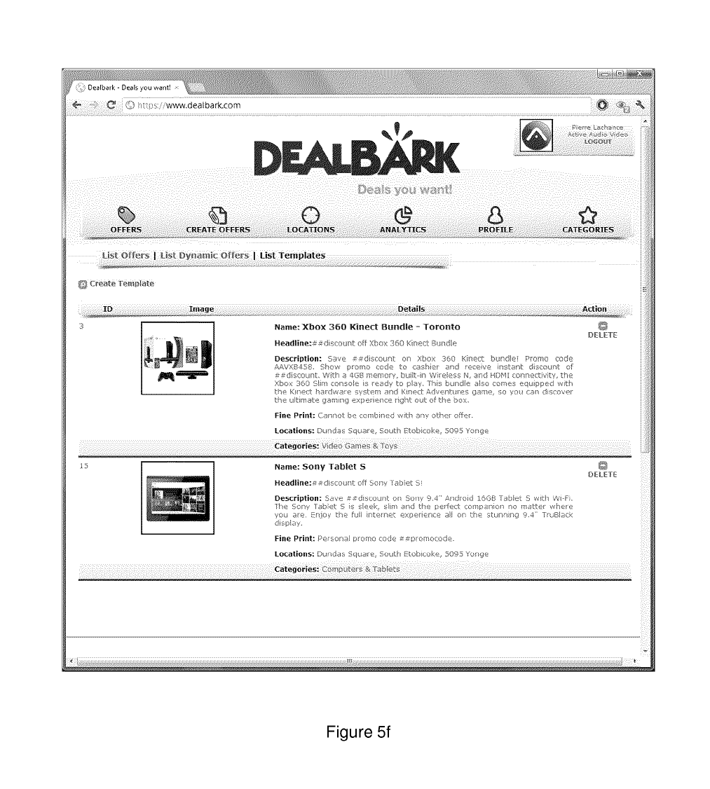

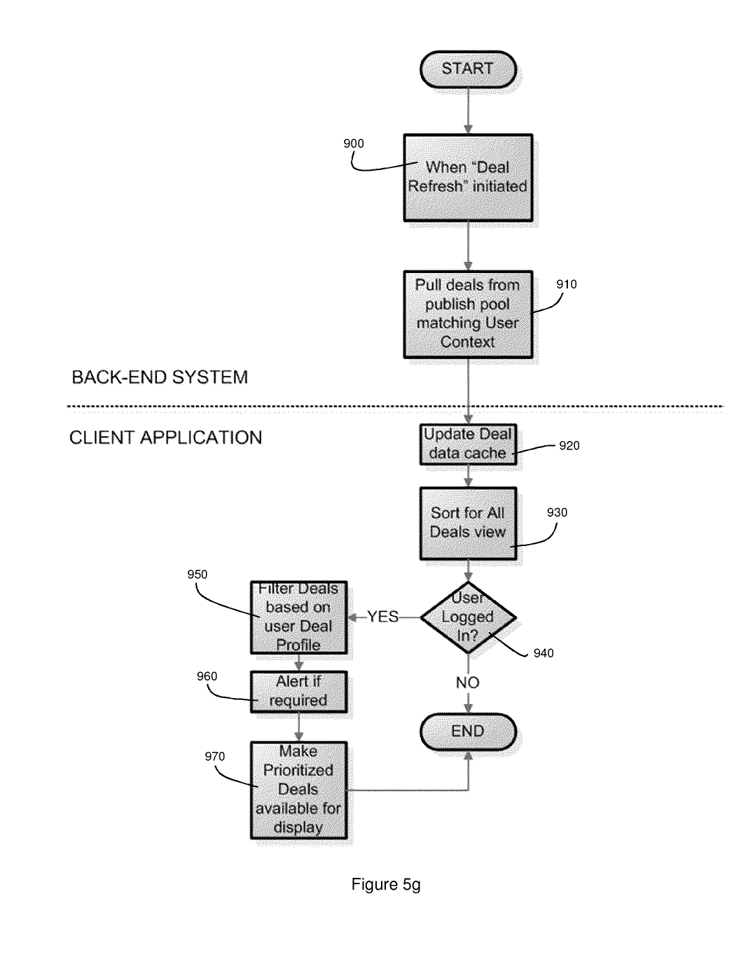

FIG. 5a shows a sample flowchart for a high-level logic diagram illustrating the flow of the system for non-dynamic offer creation, modification, deletion, and expiration, and how these affect the publish pool. As outlined previously, the publish pool may be an actual tracked group of offers or a logical grouping of the selection of offers that are available to be sent out which could be selected either by a continuously updated publish pool, or via a database query to pick up required offers as needed.

According to the present example embodiment, if the merchant is not signed up 700, they must register 840, and await notification of approval 850 (or alternately rejection 850). Upon approval, the merchant can login to the system 710. In the system, the merchant can create an offer, modify data related to an offer, and delete data related to an deal 720. If a delete is done 730, then if the deal has already been published 740, it is removed from the publish pool 750, such that it will no longer be available to client applications upon the next offer data request from client applications. If the deal has not already been published 740, then it is simply marked as deleted such that it never enters the publish pool. If a new deal is created 830, then when publish time comes 800, then the deal is added to the publish pool 770. If a modification has been done then if the offer is already published 790, the modified offer is added to the publish pool so that changes are picked up on next deal refresh. If the modified offer has not been published 790, then the updated offer is simply stored until publish time 800, at which time it is added to the publish pool 770. The publish pool also includes any triggered dynamic deals 810, and does not include any offers which are expired 830.

FIG. 5b shows a sample system “Create Offer” screen. This allows the user to create an offer, including image, headline, description, fine print, publish date, start and end date, locations and category selection.

FIG. 5c shows the bottom of the sample system “Create Offer” screen, including location and category selections.

FIG. 5d shows a sample system “Offer Listing” screen. This screen lists all offers on the system, and details of each. The listing can be filtered by status.

FIG. 5e shows a sample “Create Template” screen. A template defines parts of an offer that can then be used over and over. In this sample, the template includes template name, image, headline, description, fine print, locations, and categories.

FIG. 5f is a sample system “Template Listing” screen. This lists the templates that have been created and their details.

Upon successful registration/sign-up (which may include payment by fixed fee, subscription or other means), the merchant can log-in to the back-end offer management system. Once logged in, the merchant has the option to create a new offer, modify an existing offer, or delete an existing offer.

If an offer is deleted, and the offer has already been published, then the offer is removed from the publish pool, the effect being that it may be removed from display on client devices. If the offer in question has not yet been published, it may be marked as deleted, the effect being that it will never enter the publish pool.

When a new offer is created, once the offer publish time arrives, the offer is added to the publish pool. The publish time can be “now” or “immediately”, in order to have it propagate to client devices immediately in real time. Alternately, the publish time can be set to a future date and time. If a not-yet-published offer is modified, then the offer remains pending until the publish time arrives, at which time it is added to the publish pool. If an already-published offer is modified, it is immediately added to the publish pool so that the changes go out in real time. The publish pool is continuously updated to ensure expired offers are removed in real time, the effect being that they are immediately removed from display on any client devices.

FIG. 5g shows a flowchart of an example embodiment illustrating the flow of the system for real-time offer delivery. When a call comes to the back-end system from the client application requesting offer data 900, any user context information that is required, and which is not available or known on back-end system, is passed along as parameters with the call 900. This may include information such as, but not limited to, client-derived user location, user_id, distance preference, city, and the user offer profile. The client device deal refresh request 900 is performed on a real-time system-configurable schedule, such that the client interface is routinely or periodically refreshed and up-to-date.

Based on the incoming call 900, the back-end system will then send the group of valid offers and associated data 910 from the publish pool which fit the user context. The client application in one embodiment may have data cached, which can then compared to and updated 920 with the latest offer information, based on any changes received in the valid offers received.

In cases where the client device is running an application (as opposed to a thin client with a web interface or other client), the offers may then loaded, sorted 930, and filtered, by the client-side matching engine code in order to display the “all deals” view or other views 970. For a user with a defined offer profile, the offers are also processed by the client-side matching engine based on the user's offer profile 950, and the application handling and display of the prioritized view 970 is updated immediately. If required, the alert mechanism 960 is invoked. Depending on the user context and offer attributes, a given offer in the currently loaded group of valid offers may or may not display on all deals, My Deals, or any other application sections available.

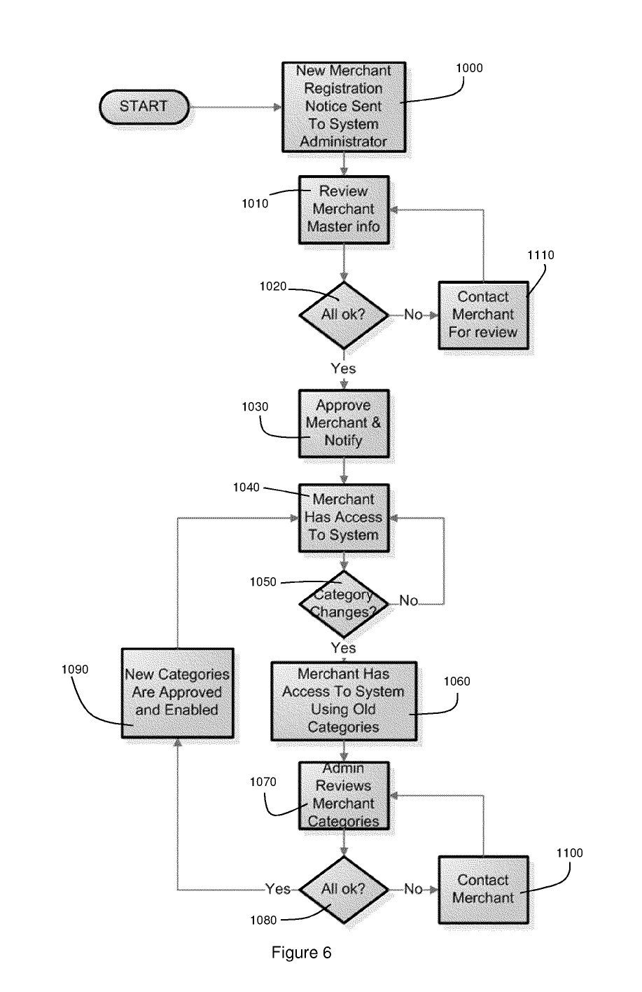

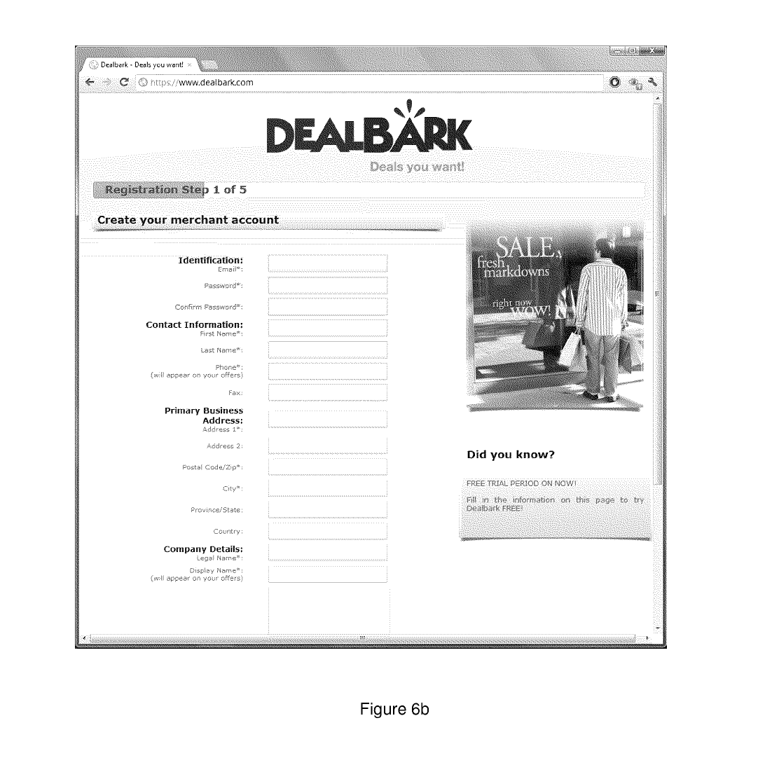

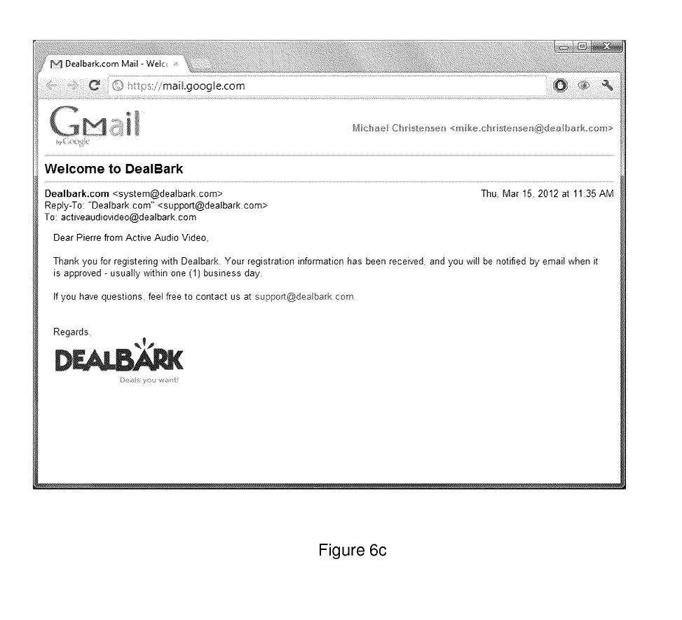

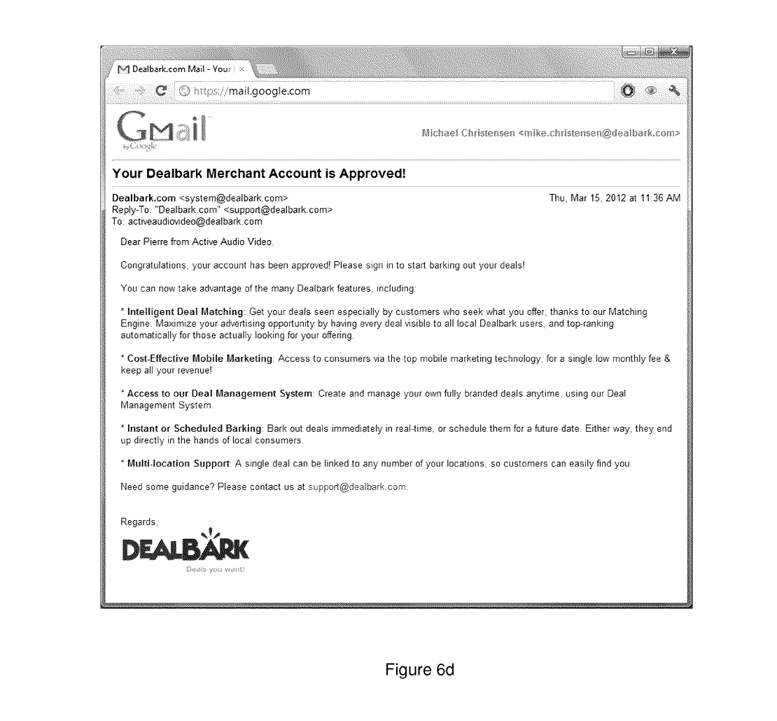

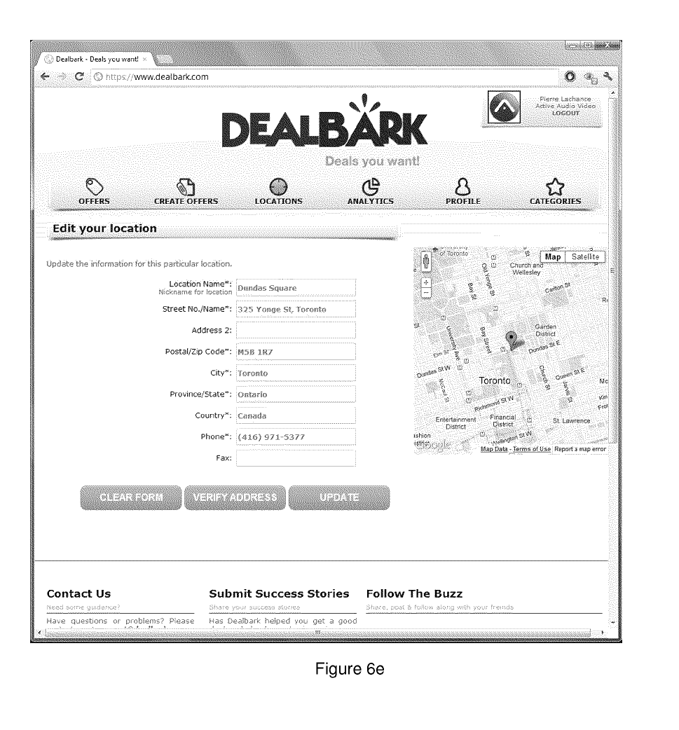

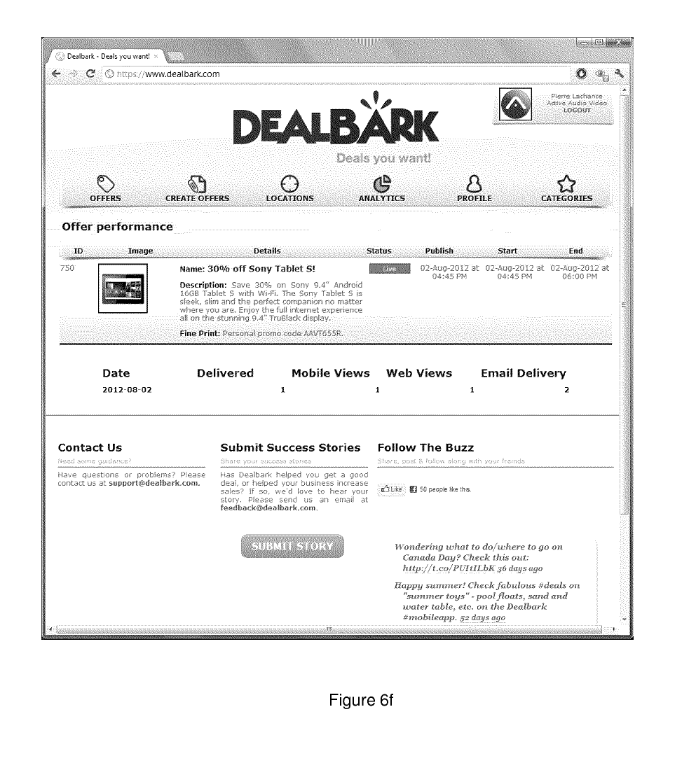

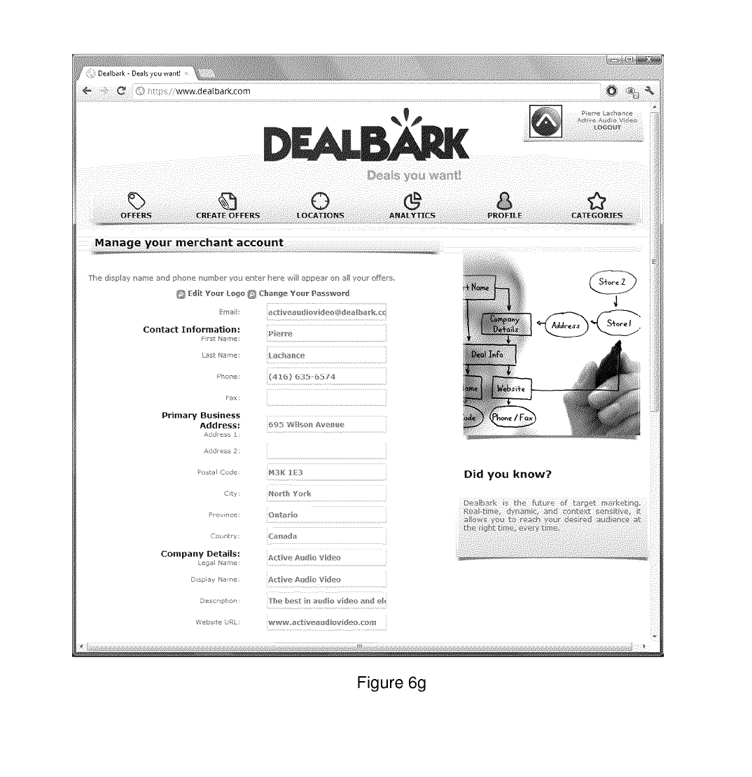

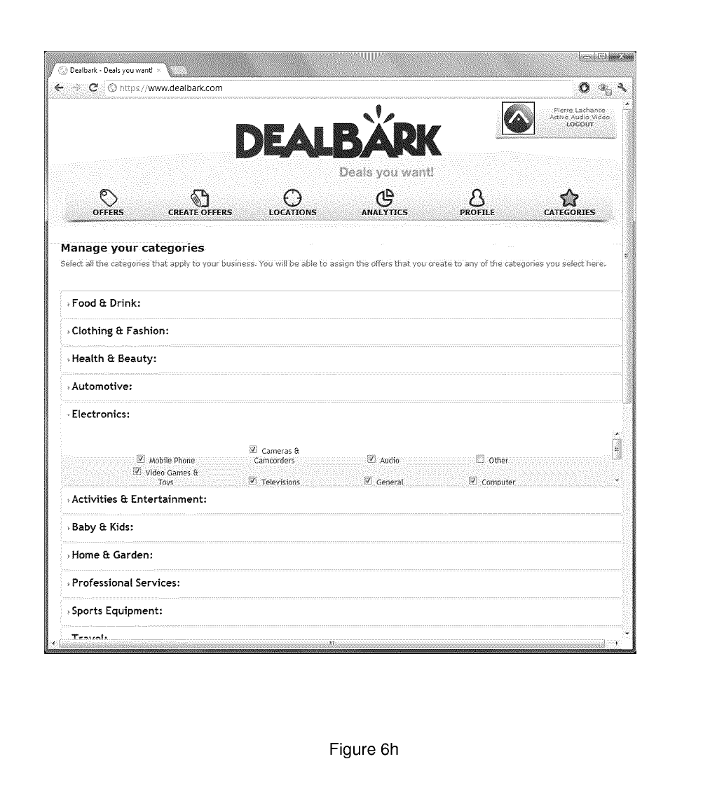

FIG. 6a shows a flowchart of an example embodiment illustrating the administration process to approve a new merchant application, as well as to approve a merchant change of category or categories after initial approval. The merchant may complete an online registration form. Upon registration submission, an electronic alert is sent to system Administrator 1000. The submission is reviewed 1010, and if approved 1030, the merchant is immediately notified and can then immediately begin creating offers on the system 1040. Processes can be in place for administrator to approve changes to merchant profiles, such as categories available to post offers in. In one embodiment, any time after initial approval, the merchant can submit modifications to their profile categories 1050. Once submitted, any new categories added cannot be used until the system administrator approves 1090 the new category selections. The merchant may continue to use old categories 1060 while new category selection approval is pending 1070. Upon approval 1090, new categories are enabled and the merchant can use the new categories.

FIG. 6a is an example screen shot of a web portal for creating a merchant account.

FIG. 6c is an example of an automated email notification a merchant would get after signing up to use the service.

FIG. 6d is an example of an automated email approval notification going to a merchant.

FIG. 6e is an example screen shot of location management, allowing the merchant to input all information about a location, verify the location, and save the location.

FIG. 6f is an example screen shot of real-time reporting of offer status. This shows real-time tracking of: delivery (consumers applications which received the offer); mobile views of the offer; web views of the offer; and email notifications of the offer. Other information can also be tracked and reported in real-time such as consumer demand for in a given category, and consumer location.

FIG. 6g is an example account management screen, allowing the merchant to update and set general information for their account.

FIG. 6h is an example of a category management screen. This allows the management of which categories a merchant can create offers in.

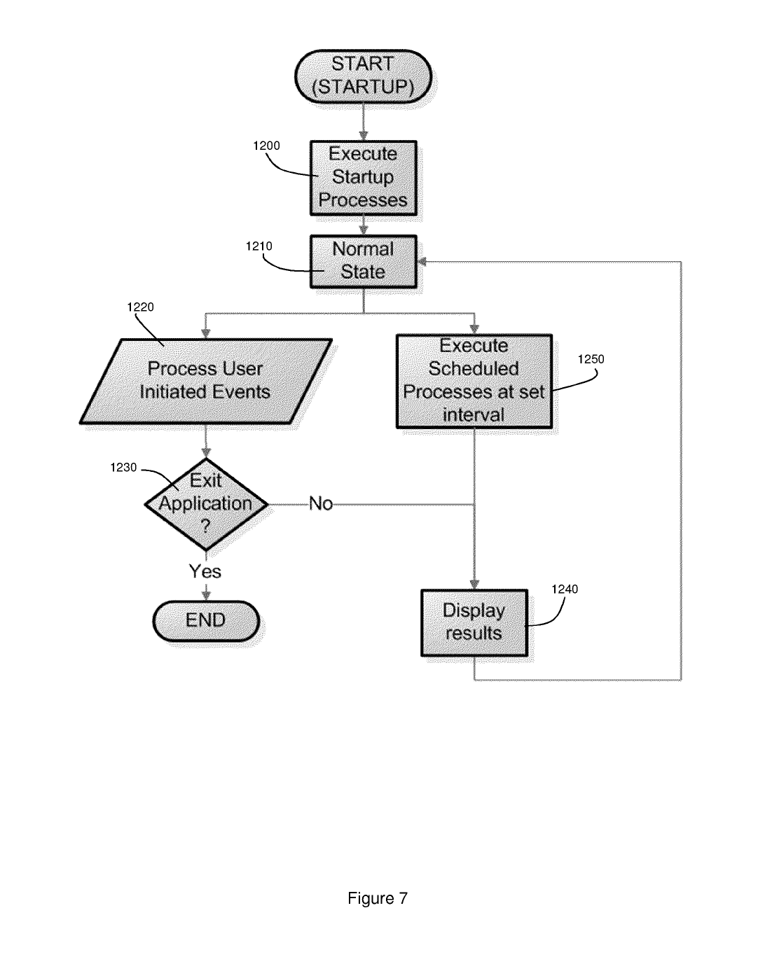

FIG. 7 shows a flowchart of an example embodiment illustrating the high-level processing of a client application such as a mobile application running on a client mobile device. Upon application startup, the startup processes 1200 are run to retrieve initial information. The application then enters its normal operating state 1210 and processes user initiated events 1220 (deal profile changes, sorts, etc.) and scheduled processes 1250 (such as scheduled calls to back-end system). Display results 1240 for any changes due to user events or scheduled processes are immediately available on the system in real-time. If the application is exited 1230, the application is halted.

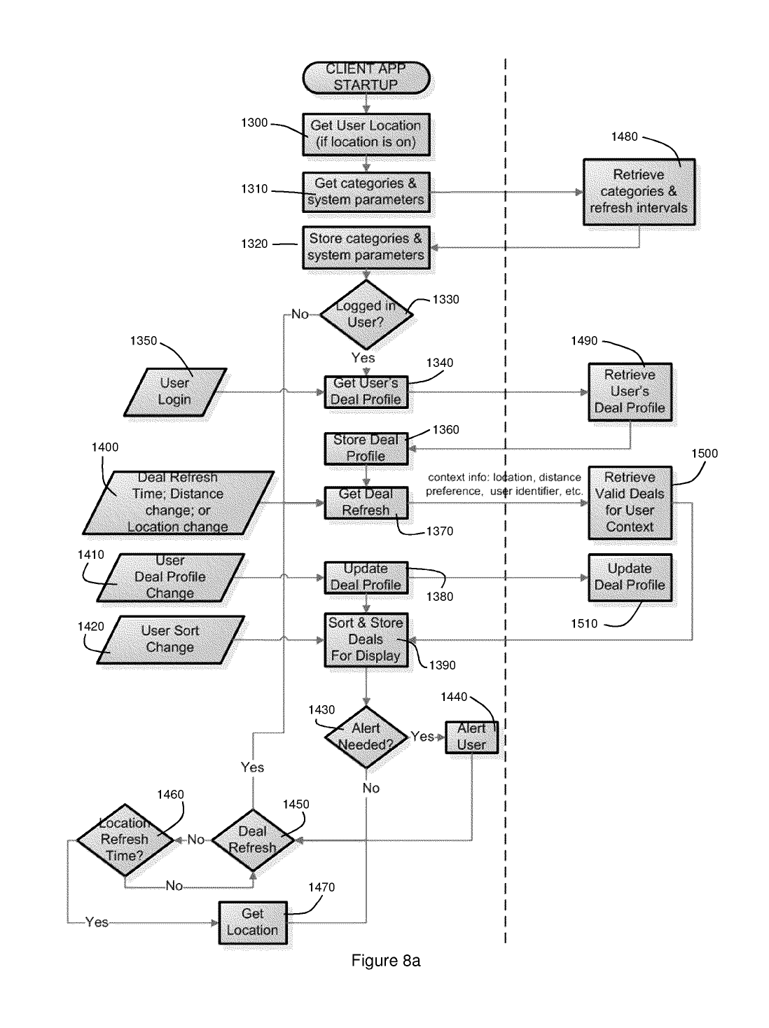

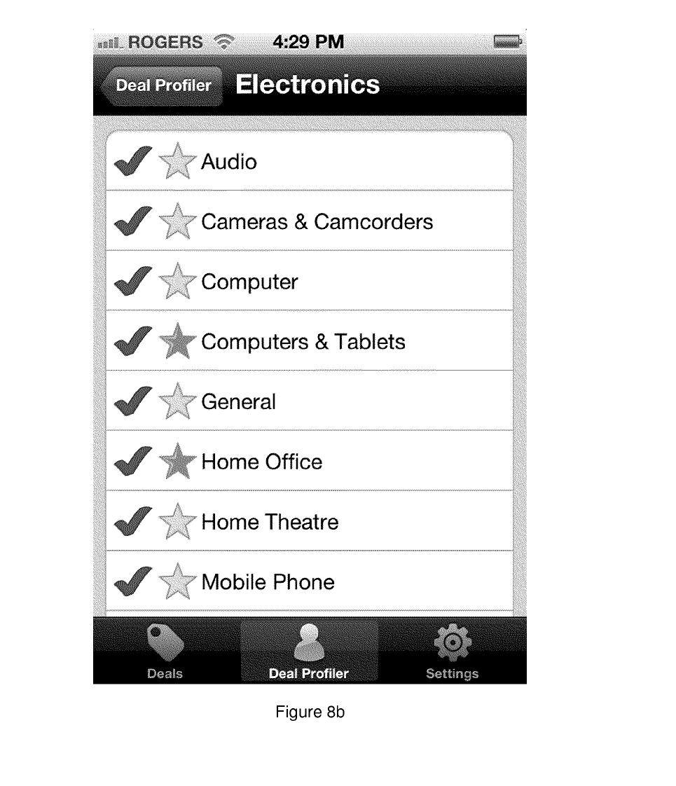

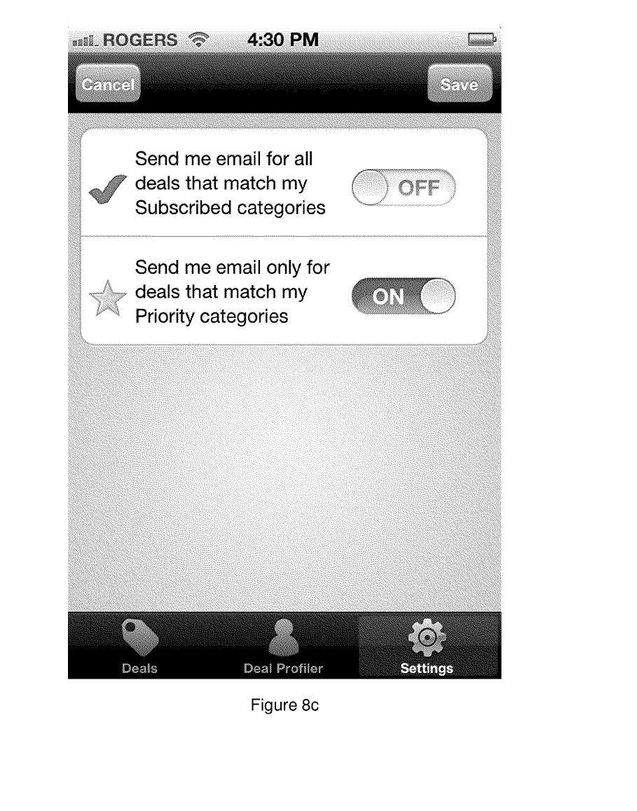

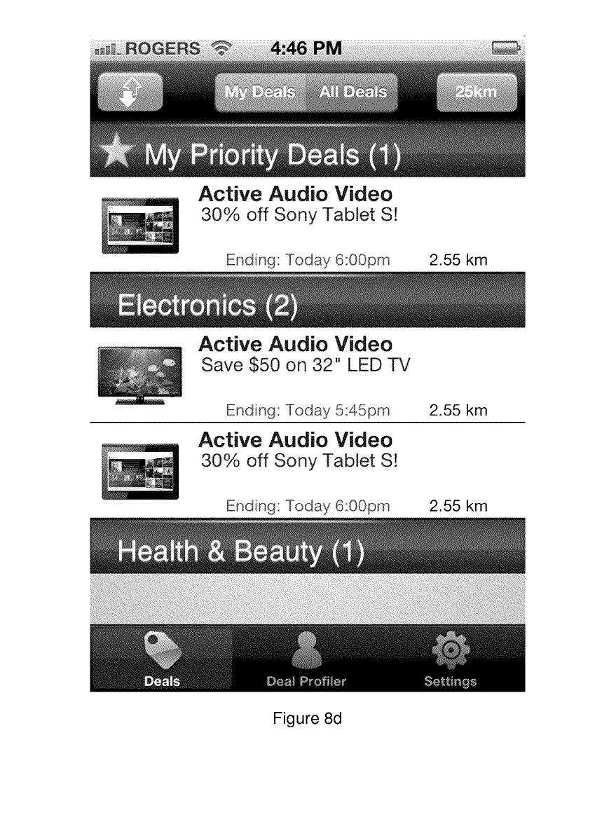

FIG. 8a shows a flowchart of an example embodiment illustrating the integration of the back-end system and the client application. Upon client application startup, the application obtains the user location 1300 if possible (for example, based on a GPS sensor of client device). The client application may also obtain data 1310 from the back-end system 1480 such as the deal category hierarchy, user settings, user preferences, and system parameters such as priority sequencing or range defaults, from the back-end system, and may store these locally 1320 on the client device.

If the user is logged in 1330, or if the user at any time logs in 1350, the client application will retrieve the user's deal profile data 1340 from the back-end system 1490, and process and store it 1360. The client application will then perform a deal refresh 1370, retrieving valid deals from the back-end system 1500 based on the user context information, and processing it locally 1390.

The sort and store processing 1390 involves managing changes to the deal data including managing offer additions, modifications, and deletes from existing valid offers such that the data sent to the client application represents the current valid offers for the user context. The sort and store processing may also involve sorting the offer data, and arranging it and storing it as required for the “all deals” view and other potential views, and if the user is logged-in or otherwise identified, arranging data as required based on the offer profile for the prioritized view. Furthermore, if the matching engine determines that the deal matches location settings (for example, the user city setting or user current location combined with distance preference), then the deal can display in the “all deals screen” for the user to browse.

According to the present embodiment, the matching engine-related components of this sample flowchart (1310, 1480, 1320, 1340, 1490, 1360, 1370, 1500, 1380, 1510, 1390, 1430, 1440, 1450, 1400, 1410, 1420) will process user context information into account in order to determine which offers to display to the user, and how to display them. In one non-limiting example, a user may have a context of:
a) a particular location latitude x, longitude y;
b) a distance preference of maximum 10 kilometers;
c) a priority set on the Cameras category;
d) a preference for Canon cameras;
e) in a city with current temperature 23 degrees Celsius and sunny weather;
f) a preference for Merchant X;
g) a Gold loyalty level with Merchant X loyalty program;
h) has bought $728 worth of merchandise from Merchant X in the last 6 months;
i) current date and time of Thursday Aug. 4, 2011 at 2:46 pm Based on this user context date, the Matching Engine will:
1. Select valid offers 1500:
   a. Provide regular offers from Merchant X that are published;
   b. Provide dynamic offers from Merchant X that have been which have been triggered based on triggering logic and offer trigger parameters, which for example may include:
      i. day and/or date
      ii. time
      iii. temperature
      iv. merchant inventory levels
      v. rate of sale
2. Ensure offers 1500 match user context:
   a) are available at locations the range based on consumer current location;
   b) are for cameras;
3. Rank & sort 1390:
   a) Raise the rank of offers from Merchant X;
   b) Raise the rank of offers for Canon cameras from Merchant X;
   c) Sort in order to display offers based on rank, or alternately based on another sort option or consumer sort preference such as proximity, offer start time, or offer end time.
4. Display appropriate customized offers 1390: Ensure that the appropriate dynamic customized consumer offers are displayed if applicable, based on consumer-context offer-customization trigger values and triggering logic, which could include parameters such as:
   i. Distance from closest Merchant X location;
   ii. Loyalty level;
   iii. Previous purchase history
   iv. Other categories the user has expressed interest in;
   v. Number of times user has looked at the offer;

If the matching engine determines, based on the prioritization information in the user's deal profile and other data, that the deal also should be also visible in “My Deals”, then the deal is displayed in that section based on the prioritized display settings.

In one example implementation, the system will determine if an alert is needed 1430 based on deal profile settings, and if so, alert the user 1440 by the appropriate alert mechanism which may be selected by the user. When a deal refresh event occurs (1460), which could be initiated by the client application or the back-end system, the refresh process 1370 in initiated again. Location is also checked on a regular interval 1460 in the case of for example a mobile device client application, and at that time location can again be obtained 1470.

FIG. 8b is an example of a Deal Profiler selection screen. This example has two levels, and allows the user to select categories and/or sub-categories of interest. This example also allows the user two express two levels of interest, one a “subscribe” level (checkmark), the other a “priority” level (star). By having more than one level of interest, the system can increase rank of the higher level of interest to assist with prioritizing the presentation and notification of offers. Other mechanisms that could be use include a measure of relative interest in one or more categories, such as a category interest level scale, e.g. an interest rating from 1-10, a slider control, category “like” or “love” or “want” or “need” ratings, and other variants.

FIG. 8c is an example of notification settings. This allows the user to select how they want to be informed of offers, and allow them to control which priority attribute matches result in a notification.

FIG. 8d is an example of a prioritized view. In this view:
a) Only offers matching current full consumer context (including their Deal Profile) are displayed;
b) Of the offers that match consumer context, those that are in categories set as a priority category (a star in Deal Profiler) are displayed first at the top of the view;
c) Offers are further prioritized by being sorted by distance from the user, everything else being equal, the closest will display before the one further away.

There are many mechanisms in which an offer may be prioritized. These can include prioritization rules associated with any one or more of the following non-limiting examples:
1. by physical proximity of a merchant location to the user current location;
2. by physical proximity of a merchant location to the user home location;
3. by user selection of the category as a priority category;
4. by keyword, which may be optionally associated with the category (example: “Canon” preferred within Camera category);
5. by ending time (offers ending soonest or ending latest);
6. by favourite or preferred merchant;
7. by loyalty (offers to consumer due to loyalty program membership);
8. by loyalty level (offers to consumer due to loyalty level in loyalty program);
9. by loyalty points (offers providing loyalty points to the consumer if the offer is purchased);
10. by amount of loyalty points offered (offers providing the highest loyalty points if the offer is purchased);
11. by merchants consumer has previously bought from;
12. by categories the consumer has previously bought from;
13. by amount consumer has previously purchased in a given category; and
14. by degree of consumer interest in the category as declared by the consumer (for example on a 10 point scale, or slider control).

If the matching engine determines, based on the user context, that the offer requires a user alert/notification, then the alert mechanism (e.g. a text message notification) is invoked to notify the user of the offer. The offers are then made available for the prioritized view (as well as the standard all deals view, which is always available to any user context). The system will then perform any alert required based on the alert mechanism, alert rules of the deal profiler, and device capabilities and settings.

Alerts may be done via email, SMS, mobile or tablet device audible notifications, mobile or tablet device vibration, mobile or tablet application icon badges, mobile or tablet device visual alert mechanism, or other means of consumer notification or alerting. For example, a user may have a priority offer alert notification on, in which case when an offer becomes available that matches user context and is in a priority category, the user may get an email notification in real-time providing details of the offer or guiding the user to the appropriate location to receive offer details.

The client application may, on a schedule, perform a refresh operation, such as performing a deal refresh, involving requesting updated deal data and/or deal profile data from the server and performing a local refresh of displayed deals). The application may, on a schedule, determine and update the user location. At any time, upon login, the deal profile may be retrieved and the deal refresh process is initiated. At any time, upon distance preference change, the deal refresh process may be initiated. At any time, upon deal profile change in the client application, the deal profile may be sent to the back-end system and stored, and then the deal sort and filter process may be initiated. At any time, upon sort order change, the sort process is initiated.

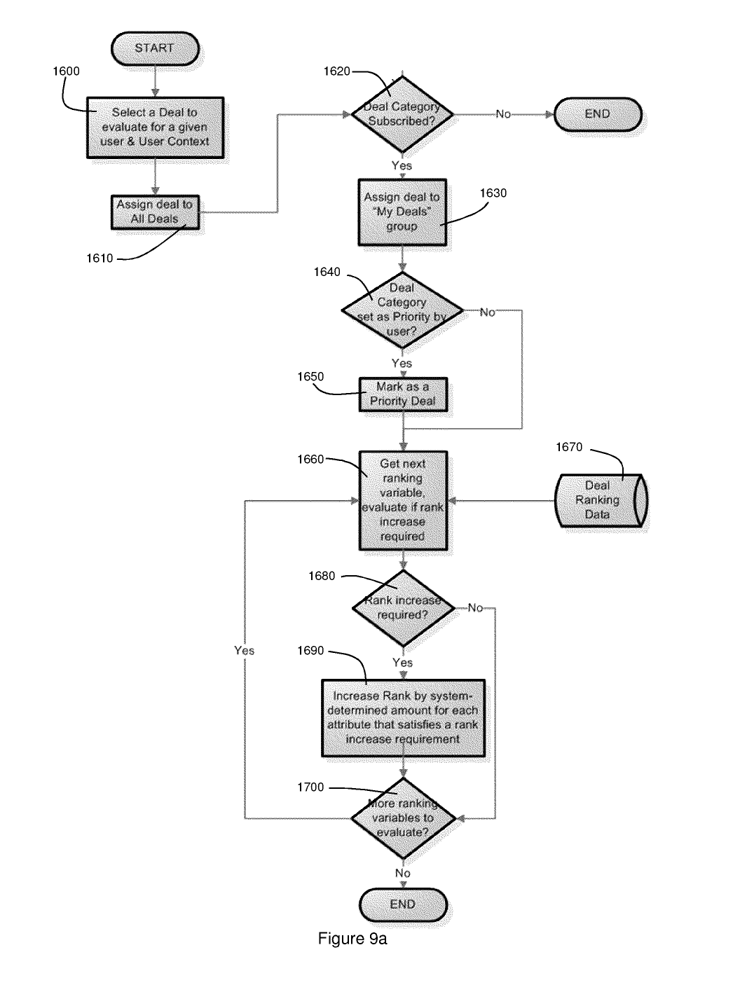

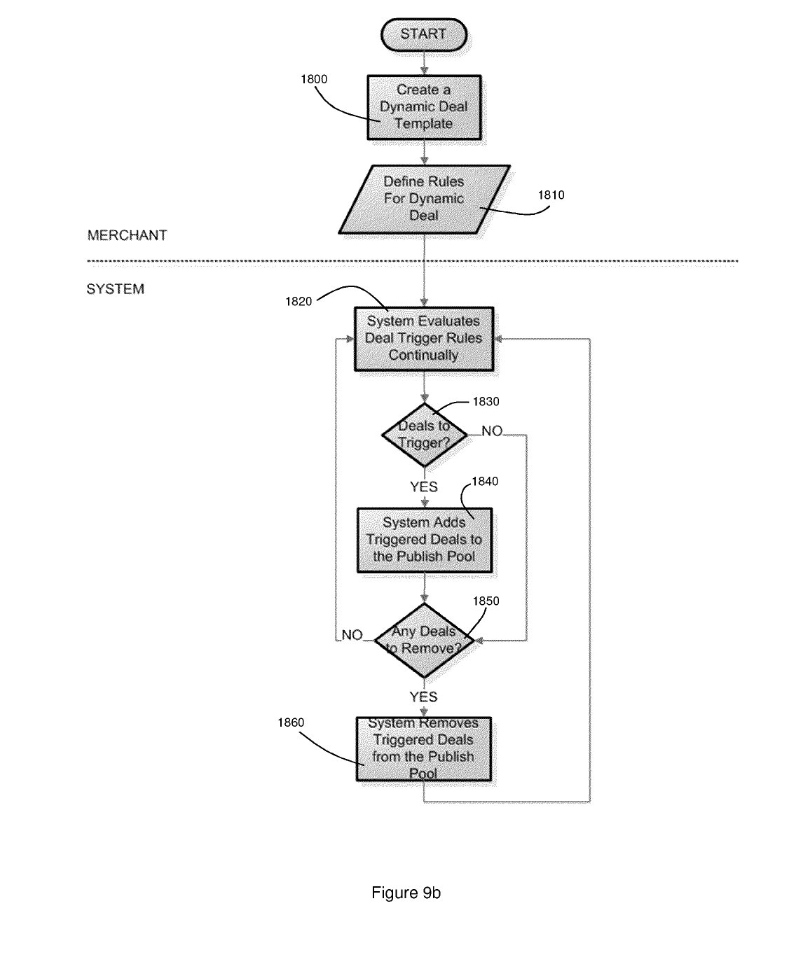

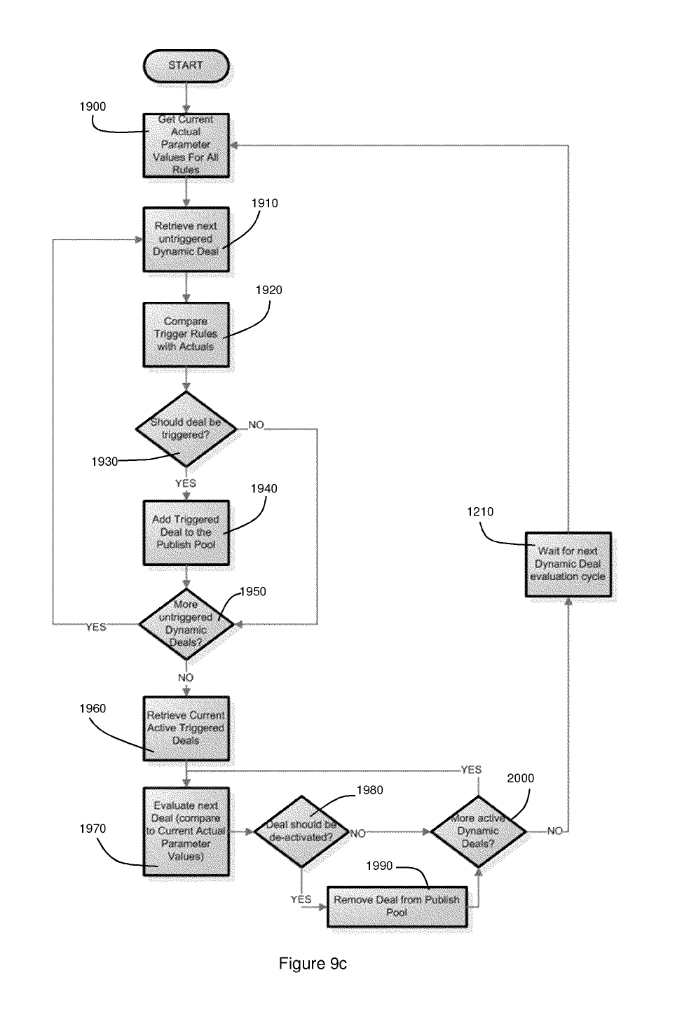

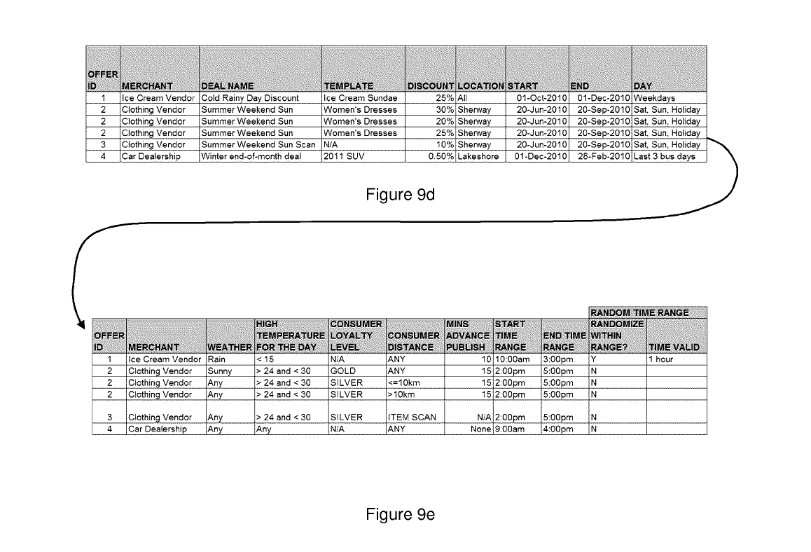

FIG. 9a is a flowchart of an example embodiment illustrating deal prioritization processing and ranking by the client application. In one embodiment, an offer may be evaluated for a given user context 1600. It can first be assigned to the “All Deals” group 1610. Then if there are no Deal Profile attributes selected for this offer 1620, the process can end. If there are attributes applicable to this deal set in the Deal Profile, the deal can become part of the prioritized subset “My Deals” 1630. The system allows variables which could affect prioritization according to various prioritization rules, and allows them to have a rank-increase amount set in the system. This allows the system administrators to define prioritization rules to adjust which variables affect ranking and by how much, and thus to tweak prioritized display for desired effect.

For example, in one embodiment, offers belonging to the prioritized subset of offers are prioritized according to the following prioritization rules:

| ATTRIBUTE | RANK INCREASE AMOUNT |
|---|---|
| Category_set_subscribed | 10 |
| Category_set_priority | 10 |
| Keyword_match | 5 |
| Preferred_merchant | 5 |
| Per_km_distance | −1 |
| Recent_in_store_barcode_scan | 20 |
| Recent_QR_code_scan | 15 |

According to the present example implementation, based on the current consumer context and the offer at hand, by increasing the rank by the increase amount each time a deal attribute matches a rank increase variable, the deal ends up with a final rank, which can then be used to present offers in the desired prioritized manner. For example, a deal may be initially assigned to “All Deals” 1610, as all valid deals are always visible in this view. If the deal category is not subscribed 1620 (i.e. rank variable 1), no further processing is performed.

If the offer category is subscribed 1630, then rank is increased by the system-set amount, and it is thus higher ranked than an offer from a non-subscribed category. If the offer category is subscribed and also set as a priority category 1640 (i.e. rank variable 2), then the offer rank is increased by the system-set amount for that rank variable, and it is thus is ranked higher than an offer from a category that is only subscribed. Other attributes can be used to increase rank 1660, for example a keyword (i.e. rank variable 3) optionally assigned to a category, such as the “Canon” keyword assigned to the “Cameras” category. If the ranking variable “keyword” on the category matches a keyword in the offer 1680, then rank would also be increased by the system-set amount for that variable 1690, and the next rank variable, if any, would then be evaluated 1700.

It is to be understood that a keyword need not be associated with a category. For example, in one example embodiment, if the keyword on an offer is not associated with a subscribed category (i.e. not in prioritized subset), then that offer could be also included the prioritized subset, for example, in a system “keyword hit” category. In another example embodiment, if the keyword is associated with an offer that is subscribed (i.e. is in the prioritized list) then the priority ranking of that offer could be increased.

Rank may also be adjusted based, for example, on the scanning of a machine readable identifier associated with the offer during a time interval (e.g. scanned by the user in-store, or scanned via an ad or other display of a product QR code). In another embodiment, rank may be adjusted according to measures associated with the user's internet or email history, such as the number of times that the product, or product category, was presented in web search results within a given time interval.

Offers that are prioritized may be displayed in the prioritized area of the client application in system-determined prioritized sequence, user-selected sequence, or other sequence. Offers with higher ranking may be displayed above offers with lower ranking, or a visual indicator may be used to indicate rank (such as full green for top-range rank, yellow for middle-range rank, red for lower-range rank).

FIG. 9b shows a flowchart providing an overview of an example dynamic offers process. This process shows the actions and inputs required by the merchant and how those inputs are then processed by the system. A merchant defines an offer to be dynamically activated by defining the rules to trigger it and optionally rules for consumer customization 1810, known herein as customization triggers. Some offer details such as image and description may be defined separately, for example in a reusable template 1800, or could be defined together with the dynamic offer trigger and customization details. The merchant can add one or more of the available offer trigger or offer customization trigger parameters, and define values or ranges or other trigger settings for each offer trigger or offer customization trigger parameter, which would cause that parameter to be considered satisfied. The dynamic offer parameters are then saved 1810, and from that point on, the offer may be triggered by the system when enough parameters are satisfied 1820 to trigger 1830 the offer (this may be all the rules defined, or some subset thereof as defined in the dynamic offer).

If an offer is triggered, it is added to the publish pool 1840 and is then available to be sent to and displayed on user client applications in the same manner as a regular offer. Any previously triggered dynamic offers can be removed from the publish pool if their trigger conditions are no longer valid, or if their end date/time has been reached (either of these two may be used to terminate the dynamic offer automatically in alternate embodiments), or if the dynamic offer has been deleted or suspended. If for any such reason it is determined a dynamic offer should no longer be available 1850, it is removed from the publish pool 1860.

The dynamic offer rules 1810 may require all parameters to be satisfied to be active, or a subset thereof which passes a system defined threshold based on extrinsic user context information (for example, the offer may declare that at least one of temperature specified or weather conditions specified must be true). In addition, the dynamic offer may have different discount values or offer details depending on which dynamic offer parameters are satisfied according to the extrinsic user context information, how many are satisfied, or to what extent they are satisfied. There may be additional details provided such as ability to randomize for example the discount amount, or randomize the time the offer is activated, within a given range.

FIG. 9c illustrates an exemplary system flow to process and activate or deactivate dynamic offers. In one embodiment, this process may operate on a continual cycle basis 2010 as a mechanism to provide real-time activation and deactivation of dynamic offers based on the current values of the trigger parameters set in the dynamic offer rules. For example, if one of the rules set in a dynamic offer uses the temperature parameter and states that temperature must be over 24 degrees Celsius for the offer to be triggered, and the current actual temperature value is 26, then that offer trigger parameter can be considered satisfied. To evaluate dynamic offers for potential activation, current actual parameter values are retrieved either up-front 1900, as displayed in this diagram, or could be cached or retrieved in real-time. In any case, current actual parameters represent the current value for each parameter.

The parameter settings for each dynamic offer that is not currently active 1910 is compared to actual parameter values 1920 in order to see if the dynamic offer should be triggered 1930. If enough conditions are satisfied, the offer is considered triggered, and a full offer is created and added to the publish pool 1940. In adding the offer to the publish pool, any dynamic text placeholders or identifiers in the offer text are replaced by real values. For example, the discount amount (identified in FIG. 5e by “##discount”) and potentially a coupon code (identified in FIG. 5e by “##promocode”) could be added at this point as part of offer generation. A unique identifier, identifying a specific offer made to a specific consumer, could be added to offers in the publish pool as part of the offer delivery process to a given client application.

Once all non-triggered dynamic offers have been evaluated 1950, the system may evaluate current triggered offers 1960, 1970 to see if any should be deactivated, i.e. removed from the publish pool. To evaluate dynamic offers for potential deactivation, the system may loop 2000 through all triggered (active) dynamic offers, and verify if the current actual parameter values still satisfy enough of the dynamic offer parameter settings to keep the dynamic offer active 1980. If not, the offer is removed from the publish pool 1990.

In another embodiment, a multiple logic conditions could be employed, and a weighted score or total (aggregate) score used for the system to decide whether to trigger the offer. For example, if a dynamic offer rule states temperature must be over 24 degrees Celsius, and the actual temperature is 26, then a score of 2 can be used (26−24), and can be used alone or added to other scores to come up with a total score for the parameter, or for all the dynamic offer trigger rules. This score can then be compared to a minimum value defined for that parameter or for all trigger parameters as required for triggering, and thus used for the decision of whether to trigger the offer or not.

FIGS. 9d and 9e shows a sample of four potential dynamic offers. This illustrates some types of parameters which may be used, but is not meant to be an exhaustive list. The parameters may be dynamically defined in the system such that the system administrators can add or modify the available parameters, parameter value options, and activation options, at any time. Any number of parameters can be used.

Dynamic Offer parameters can be classified into two categories:
1. Extrinsic Offer Triggers: These are parameters which, when satisfied, will cause the offer to be triggered for at least some users. Examples include weather, inventory level, date, time, and day of the week. These can be evaluated by the server to cause the offers to become part of the publish pool.
2. Customized Offer Triggers: These are parameters which can personalize an offer for a given consumer, based on if and how a consumer satisfies the parameters at the point in time the Extrinsic Offer Triggers are satisfied. Examples include Loyalty Level, distance from physical store or specific location, sex, age, and purchase history. These are evaluated by the system on a user-by-user basis, in order to pull the appropriate offers from the triggered offers available, for example, in the publish pool.

For example, in FIG. 9d, offer 2 (“Summer Weekend Sun”, lines 2A, 2B and 2C) and offer 3 (“Summer Weekend Sun Scan) offers are all triggered if the following extrinsic offer triggers are met:
a) Date is between Jun. 20, 2010 and Sep. 20, 2010;
b) It is a Saturday, a Sunday, or a Holiday;
c) It is Sunny weather;
d) Temperatures is greater than 24 and less than 30;

In terms of the offer a given consumer will receive, that is dependent on the following Customized Offer Triggers:
a) Per line 2A, a GOLD loyalty member will receive an offer for 30% off;
b) Per line 2B, a SILVER loyalty member will receive an offer for 20% off if they are less than or equal to 10 km away from the nearest store;
c) Per line 2C, a SILVER loyalty member will receive an offer for 25% off if they are farther than 10 km away from the nearest store.
d) Per line 3A, a non-loyalty member who scans the item in-store will be offered a 10% discount.

In this way, offers can be dynamically triggered based on variables particular to the merchant (inventory, sales rates, and so on), extrinsic variables particular to the general environment (day, date, weather, and so on), variables particular to general attributes of consumer context (loyalty level, purchase history, and so on), and variables particular to specific attributes of immediate consumer context (current location, recent activity, Offer Profile settings, and so on). This can be employed to provide electronically-automated customized price discrimination.

A merchant or retailer can define as many dynamic offers as they like, each having as many offer trigger and/or customized offer trigger parameters as they like, and as many rule lines as they like, on as many products as they like. This may be defined directly in the system via the management screens, or electronically by imported data via a merchant API.

Note that in the case of location, and in some other cases, once a consumer has received a given discount offer, the offer remains in effect for that consumer for the duration of that offer. For example, the 25% discount offer for a consumer satisfying conditions for 2C (greater than 10 km away at time of receipt of offer), will not change to 20% discount based on that consumer going closer to the store. This is done by the system storing which offer went to which consumer, and not sending any different offer for offers which include customization parameters such as distance, which require that the offer remain static once issued. This is to prevent a given consumer from getting a different offer for the same item from the same merchant location as they approach a physical store, simply because they are approaching the store—and not due to any other intentional reason (which could include the intention to offer different discounts as a user approaches a physical store or other landmark).

Some examples of customized price discrimination (based on extrinsic offer triggers and/or customized offer triggers) that could be created using the dynamic offers technology and process are:
a) day or days of the week
b) specific store locations
c) current weather
d) temperature
e) merchant inventory levels
f) merchant sales trends
g) consumer purchase history (same category, related categories, or any categories)
h) consumer previous actions within the client application
i) consumer loyalty membership
j) consumer loyalty membership level
k) consumer loyalty points or value accumulated
l) consumer Offer Profile selections or settings
m) consumer offer display preferences
n) consumer home address
o) consumer distance from nearest physical store
p) consumer current location
q) consumer payment method
r) consumer preferred financial payment tender
s) consumer credit card ownership
t) a time range within any of the above

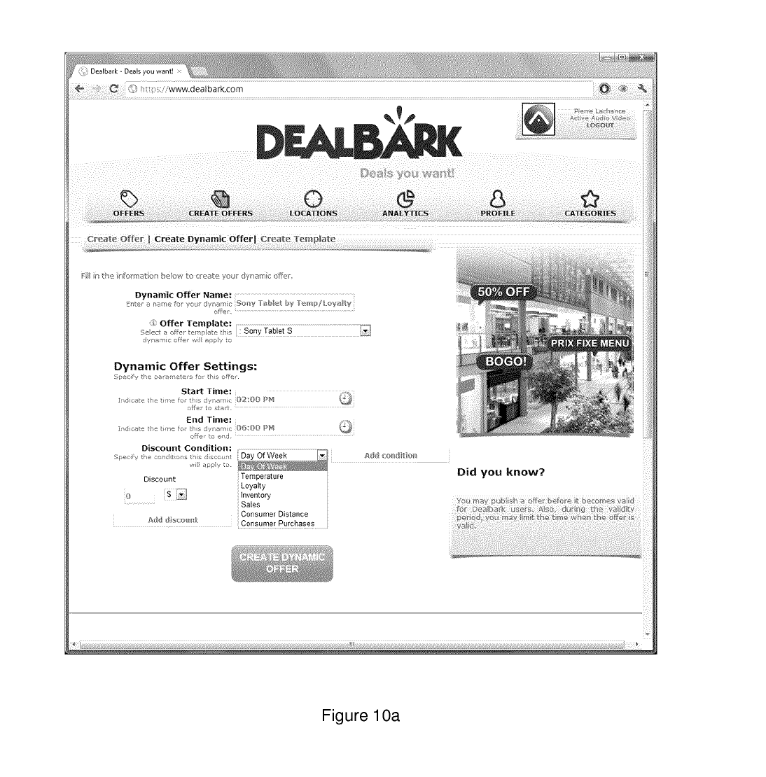

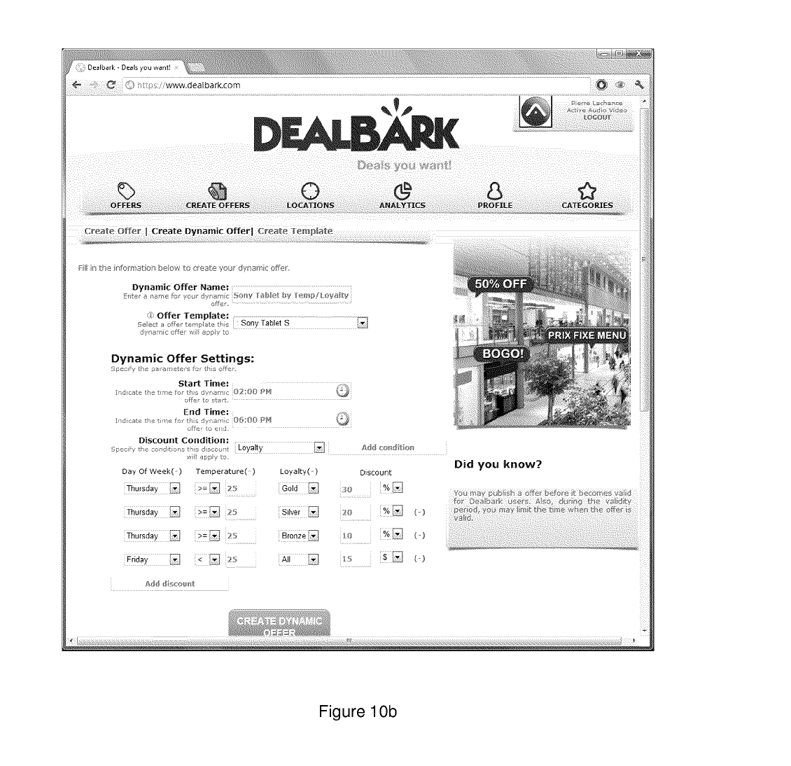

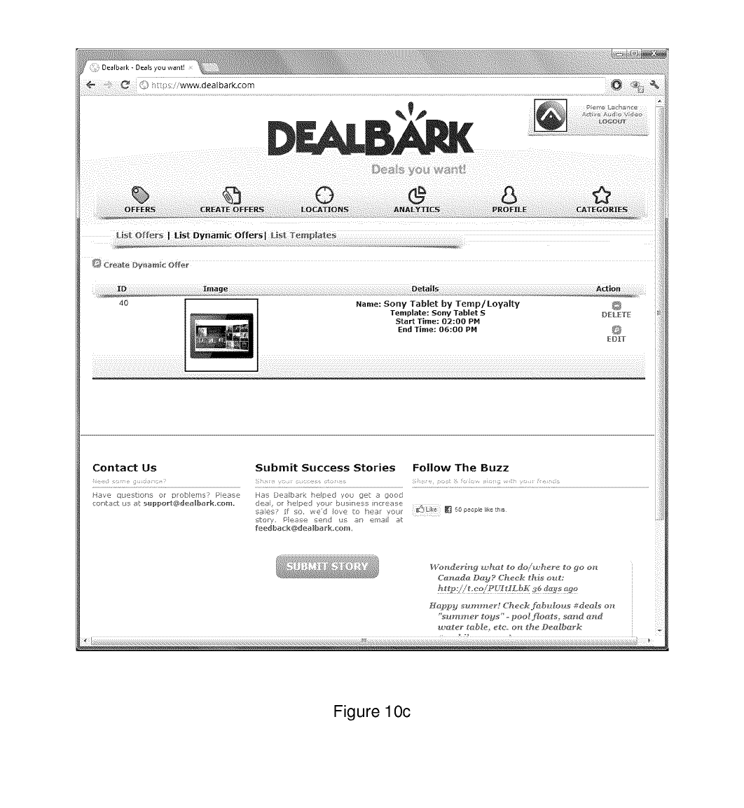

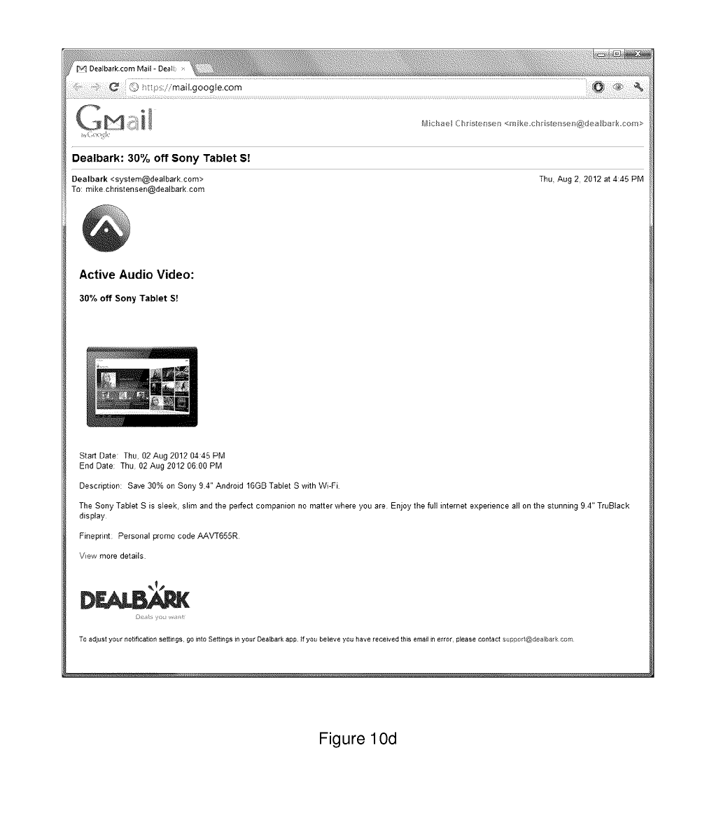

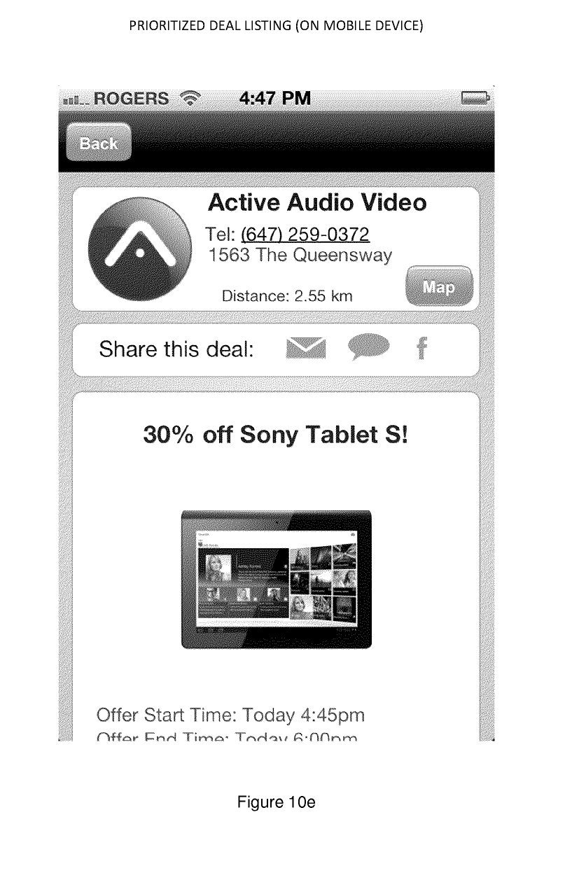

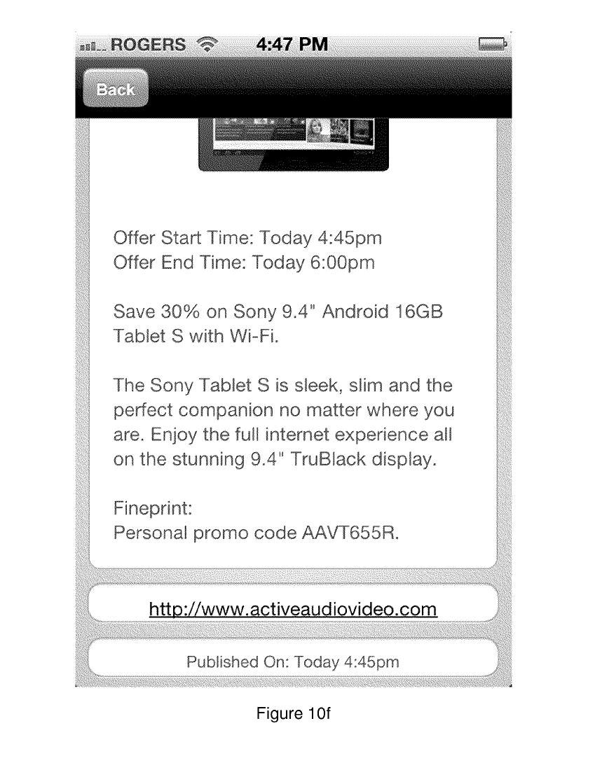

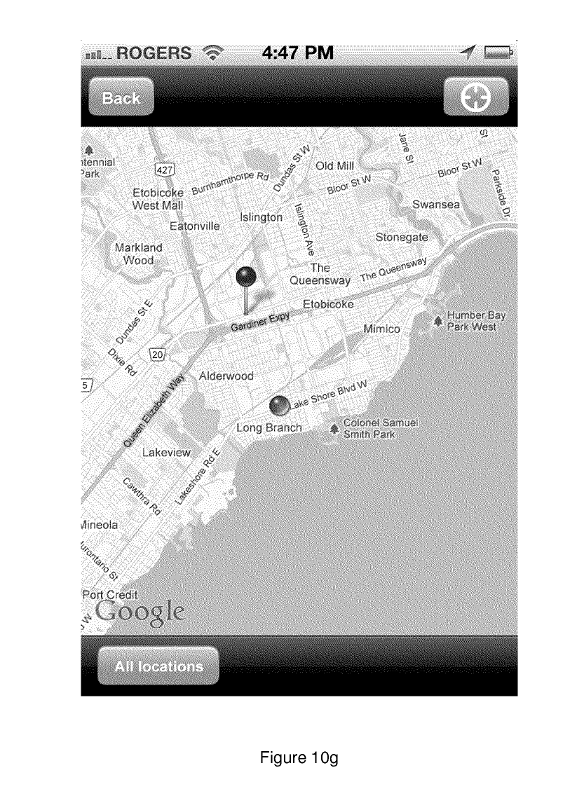

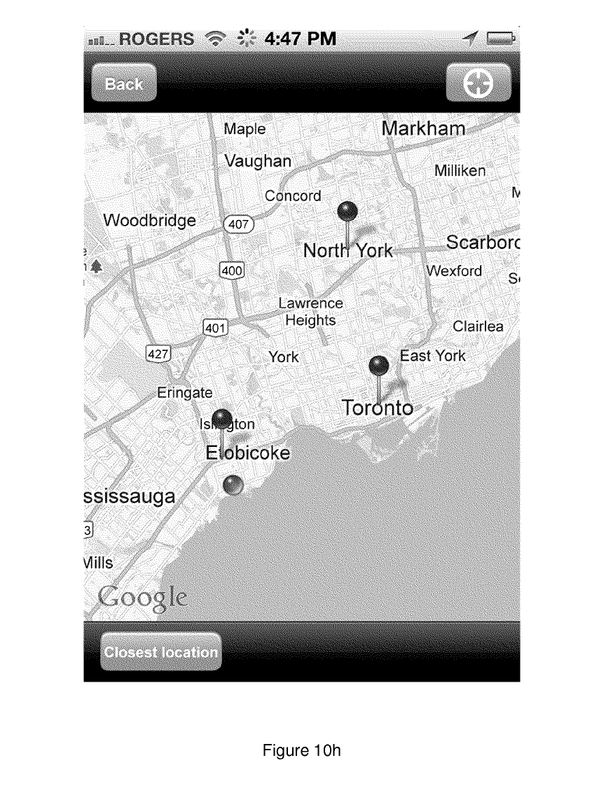

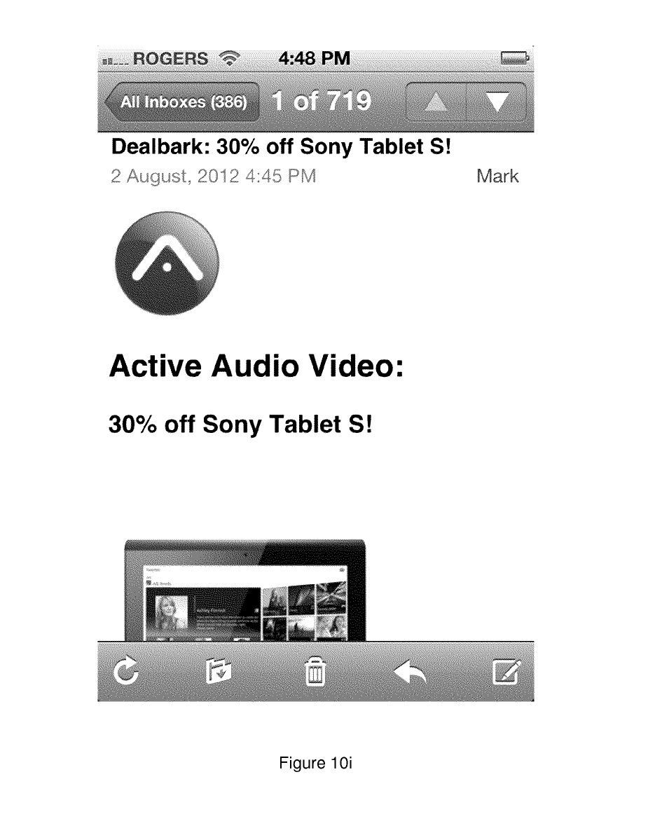

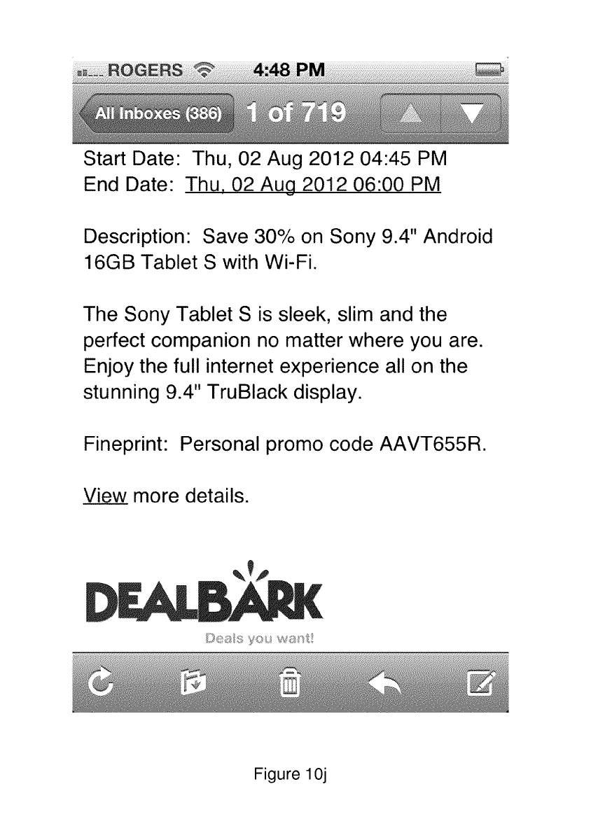

FIG. 10a is an example of a dynamic offer creation screen. This example shows the ability to: name the dynamic offer; select the template to be used; define the start and end time for the offer when it is triggered; select and add offer trigger and offer customization trigger variables (identified in this figure as the values in field “Discount Condition” list along with “Add Condifion” button); specify what the discount is if the conditions on a line are true; the ability to add more lines (“Add discount” button); and finally the ability to create the dynamic offer. Note that an alternative to having specific start and end times is to allow the offer to remain triggered as long as the trigger conditions identified remain valid, which requires a frequent process which validates trigger conditions of dynamic offers.

FIG. 10b is an example of a dynamic offer with three trigger variables (Day of Week, Temperature, and Loyalty) and four rows of trigger data completed. Any number of trigger variables and rows can be added or deleted.

FIG. 10c is an example Dynamic Offer listing screen, showing a list of dynamic offers created, and providing the ability to delete or edit them.

FIG. 10d is an example of a real-time notification email displayed on a PC browser, for a personalized dynamic offer that has become available. In this case, the discount amount of 30% reflects this particular consumer's GOLD loyalty level as defined in the dynamic offer in FIG. 10b. In addition, a personal promotion code has been included.

FIGS. 10e and 10f show an example of some of the details a personalized dynamic offer displayed on a mobile device client application. In this example, the dynamic offer has been triggered and is thus visible. The 30% discount offered reflects this particular consumer's GOLD loyalty status. A personal promotion code has been generated by the system identifying this specific offer to this specific consumer. The nearest location to the user is automatically identified with address and phone number.

FIG. 10 g shows an example of an offer map on a mobile device client application, identifying the location of the both the user and the nearest merchant location for that offer to the user.

FIG. 10h is an example of a map on a mobile device client application identifying the user location and all locations for that offer in the city.

FIGS. 10i and 10j show an example of a real-time notification email received and displayed on a mobile device, for a dynamic offer that has become available.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method of determining a prioritized subset of electronic offers for display on a client device associated with a user, the method comprising:
a) obtaining user context information associated with the user;
b) obtaining, a set of valid offers that are associated with the user context information;
c) processing the set of valid offers and the user context information to identify a set of matching offers that is relevant to the user; and
d) processing the set of matching offers and the user context information according to offer prioritization rules to obtain a prioritized subset of the matching offers for display on the client device.

2. The method according to claim 1 wherein the user context information includes offer prioritization information provided by the user.

3. The method according to claim 2 wherein the user context information includes category subscription information, and wherein the offer prioritization information indicates priority categories, such that offers associated with the priority categories are prioritized within the prioritized subset.

4. The method according to claim 2 wherein the offer prioritization information includes a measure of relative interest in one or more categories.

5. The method according to claim 1 wherein the offer prioritization rules are associated with any one or more of physical proximity of a merchant location to the user current location; physical proximity of a merchant location to the user home location; user selection of a category as a priority category; one or more keywords; ending time of offer; favourite or preferred merchant; loyalty program membership; loyalty level; loyalty points accrued; amount of loyalty points offered; merchants from which the user has previously bought from; categories the user has previously bought from; amount user has previously purchased in a given category; and degree of user interest in the category as declared by the user.

6. The method according to claim 1 wherein the offer prioritization rules for a given offer are associated with the scanning of a machine-readable indicator associated with the given offer by the user.

7. The method according to claim 1 wherein step (d) includes:
computing a ranking score for each offer in the prioritized subset, wherein the ranking score is determined according to prioritization rules; and
ranking the offers within the prioritized subset according to the ranking score.

8. The method according to claim 7 further comprising displaying, on the client device, a visual indicator associated with a rank of each deal within the prioritized subset.

9. The method according to claim 7 wherein the prioritization rules specify one or more logical conditions, such that a priority status of a given offer is increased when a given logical condition is satisfied, and wherein the ranking score is determined based on the evaluation of the logical conditions.

10. The method according to claim 9 wherein the ranking score for an offer is computed by:
evaluating each logical condition, and in the event that a logical condition is satisfied, determining a rank increase value associated with the logical condition; and
summing the rank increase values to obtain the ranking score.

11. The method according to claim 1 further comprising providing a notification to the user to alert the user to the availability of one or more of the offers of the prioritized subset.

12. The method according to claim 1 wherein steps (a) through (d) are performed by a server, wherein the method further comprises:
e) transmitting the prioritized subset of matching offers to the client device.

13. The method according to claim 12 further comprising performing steps (a) to (e) one or more times for one or more additional users.

14. The method according to claim 12 wherein step (b) further comprises:
obtaining all valid offers, for optional display on the client device.

15. The method according to claim 12 wherein processing the set of matching offers is performed by the server, and wherein the prioritized subset is provided to the client device for display.

16. The method according to claim 1 wherein steps (a) through (d) are performed by an application residing on the client device.

17. The method according to claim 16 further comprising the step of displaying the prioritized subset of matching offers on the client device.

18. A method of dynamically triggering the availability of an offer for display on a client device, the method comprising:
a) obtaining a set of offers, at least one of said set of offers having associated therewith one or more customized offer trigger parameters and triggering logic, wherein the customized offer trigger parameters are dependent on user context information associated with a user of the client device;
b) obtaining the user context information and evaluating the customized offer trigger parameters for each offer; and
c) processing the triggering logic and the customized offer trigger parameters, and dynamically triggering a matching offer when the triggering logic is satisfied.

19. The method according to claim 18 further comprising customizing a matching offer according to the user context information.

20. The method according to claim 19 further comprising maintaining a customized matching offer despite changes in the user context information, until the triggering logic is no longer satisfied.

21. The method according to claim 19 wherein customizing a matching offer according to the user context information includes customizing a discount level of the offer.

22. The method according to claim 18 wherein the user context information includes extrinsic user context information.

23. The method according to claim 22 wherein extrinsic context information includes environmental information associated with a location of the user.

24. The method according to claim 18 wherein in step (c), processing the triggering logic associated with a given offer includes processing multiple triggering logic conditions to determine a score associated with each triggering logic condition, and triggering a matching offer based on an aggregate score.

25. The method according to claim 24 further comprising applying a weight to each score prior to determining the aggregate score.

26. The method according to claim 18 wherein the customized offer trigger parameters relate to one or more of: current weather; temperature; merchant inventory levels; merchant sales trends; user purchase history; user previous actions within a client application; user loyalty membership; user loyalty membership level; user loyalty points or value accumulated; user payment method; user preferred financial payment tender; user credit card ownership; and a time range within any of the above.

27. The method according to claim 18 wherein the customized offer trigger parameters relate to one or more of: one or more days of the week; specific store locations; user home address; user distance from nearest physical store; user current location; and a time range within any of the above.

28. The method according to claim 18 further wherein steps (a) through (c) are performed by a server, the method further comprising:
d) transmitting the set of triggered matching offers to the client device for display to the user.

29. The method according to claim 28 further comprising performing at least steps (b) through (d) one or more times for one or more additional users.

30. The method according to claim 18 further comprising providing a notification to the user to alert the user to the availability of one or more of the offers of the triggered matching offers.

31. A method of dynamically triggering the availability of an offer for display on a client device, the method comprising:
a) obtaining a set of offers, at least one offer of said set of offers having associated therewith one or more extrinsic offer trigger parameters and triggering logic, the extrinsic offer triggers parameters being dependent on extrinsic user context information;
b) obtaining the extrinsic user context information for evaluating the extrinsic offer triggers parameters; and
c) processing the triggering logic and the offer trigger parameters and identifying a set of triggered offers for which the triggering logic is satisfied; and
d) activating the set of triggered offers, such that the set of triggered offers may be displayed on a client device.

32. The method according to claim 31 wherein extrinsic context information includes environmental information.

33. The method according to claim 31 wherein the offer trigger parameters relate to one or more of: current weather, temperature, merchant inventory levels, merchant sales trends, and a time range within any of the above.

34. The method according to claim 31 wherein the offer trigger parameters relate to one or more of: one or more days of the week, specific store locations, and a time range within any of the above.

35. The method according to claim 31 wherein in step (c), processing the triggering logic associated with a given offer includes processing multiple triggering logic conditions to determine a score associated with each triggering logic condition, and identifying a triggered offer based on an aggregate score.

36. The method according to claim 35 further comprising applying a weight to each score prior to determining the aggregate score.

37. A method of preparing a dynamically triggerable deal for display on a client device, the method comprising:
a) providing offer data defining an offer;
b) providing one or more offer trigger parameters, the offer trigger parameters being dependent on user context information associated with a user of the client device; and
c) providing triggering logic for determining, based on the offer trigger parameters and the context information, when a customized offer is to be activated.

38. The method according to claim 37 wherein the user context information includes extrinsic user context information.

39. The method according to claim 37 wherein the user context information includes intrinsic user context information.

40. The method according to claim 37 wherein steps (a) through (c) are performed via a web portal.

41. A computer readable medium for storing executable instructions, which, when executed in a processing system, cause said processing system to perform a method comprising:
a) obtaining user context information associated with the user;
b) obtaining, a set of valid offers that are associated with the user context information;
c) processing the set of valid offers and the user context information to identify a set of matching offers that is relevant to the user; and
d) processing the set of matching offers and the user context information according to offer prioritization rules to obtain a prioritized subset of the matching offers for display on a client device associated with the user.

42. A computer readable medium for storing executable instructions, which, when executed in a processing system, cause said processing system to perform a method comprising:
a) obtaining a set of offers, at least one of said set of offers having associated therewith one or more customized offer trigger parameters and triggering logic, wherein the customized offer trigger parameters are dependent on user context information associated with a user;
b) obtaining the user context information and evaluating the customized offer trigger parameters for each offer; and
c) processing the triggering logic and the customized offer trigger parameters, and dynamically triggering a matching offer when the triggering logic is satisfied.

43. A computer readable medium for storing executable instructions, which, when executed in a processing system, cause said processing system to perform a method comprising:
a) obtaining a set of offers, at least one offer of said set of offers having associated therewith one or more extrinsic offer trigger parameters and triggering logic, the extrinsic offer triggers parameters being dependent on extrinsic user context information;
b) obtaining the extrinsic user context information for evaluating the extrinsic offer triggers parameters; and
c) processing the triggering logic and the offer trigger parameters and identifying a set of triggered offers for which the triggering logic is satisfied; and
d) activating the set of triggered offers, such that the set of triggered offers may be displayed on a client device.
